(19) United States
(12) Patent Application Publication
(10) Pub. No.: US 2026/0122601 A1
(43) Pub. Date: Apr. 30, 2026

(54) Multi-Carrier Positioning in a Communication Network

(71) Applicant: Telefonaktiebolaget LM Ericsson (publ), Stockholm (SE)

(72) Inventors: Deep Shrestha, Linköping (SE); Muhammad Ali Kazmi, Sundbyberg (SE); Ritesh Shreevastav, Upplands Väsby (SE); Florent Munier, Västra Frölunda (SE)

(21) Appl. No.: 19/116,961

(22) PCT Filed: Sep. 28, 2023
(86) PCT No.: PCT/EP2023/076894

§ 371 Date: Mar. 28, 2025

Related U.S. Application Data
(60) Provisional application No. 63/411,838, filed on Sep. 30, 2022.

(51) Int. Cl. H04W 64/00; H04W 24/10; H04W 72/0453

(52) U.S. Cl. CPC H04W 64/00; H04W 24/10; H04W 72/0453

(57) ABSTRACT

Methods performed by a communication device and a network node and corresponding apparatuses in which a communication device (12) transmits, to a network node in a communication network (10), information (18) about a capability of the communication device (12) to perform a multi-carrier positioning measurement (14) and then it performs the multi-carrier positioning measurement (14) and the network node receives the information about the capability of the communication device to perform a multi-carrier positioning measurement and it uses the information to perform one or more operational tasks.

### TECHNICAL FIELD

The present application relates generally to a communication network, and relates more particularly to multi-carrier positioning in such a network.

### BACKGROUND

In multi-carrier (MC) operation, a communication device operates on multiple carriers that are aggregated. Examples of MC operations are carrier aggregation (CA), dual connectivity (DC), multi-connectivity (MuC), etc. Multi-carrier operation may also be referred to as bandwidth aggregation. Regardless, multi-carrier operation for communication enables a communication device to transmit and/or receive communication (e.g., control signaling and/or user data) over two or more aggregated carriers, e.g., for improved communication throughput and/or reliability. Multi-carrier operation for positioning, by contrast, enables a communication device to perform a positioning measurement over two or more aggregated carriers, e.g., for improved positioning accuracy.

Challenges exist, however, in supporting multi-carrier operation for both communication and positioning. Configuration of multi-carrier operation for communication has heretofore largely been uncoordinated with configuration of multi-carrier operation for positioning. Especially as multi-carrier operation for communication is dynamically configurable, e.g., via dynamic activation and de-activation of secondary carriers, this threatens the viability and/or efficiency of using multi-carrier operation also for positioning. For example, the number of carriers over which a communication device is to transmit and/or receive communication in multi-carrier operation may impact the ability and/or efficiency of the communication device to also use multi-carrier operation for positioning, and vice versa.

### SUMMARY

Some embodiments herein equip a communication network with information about a communication device's capability to perform a multi-carrier positioning measurement. This capability information may include for example information about a multi-carrier configuration with which the communication device is capable of performing a multi-carrier positioning measurement, e.g., how many carriers, which carriers, the individual or aggregated bandwidth of the carriers, measurement gap requirements, etc. Regardless, equipped with this capability information for multi-carrier positioning, the communication network may advantageously adapt and/or otherwise coordinate configuration of the communication device with multi-carrier operation for communication. The communication network may for example coordinate multi-carrier operation for communication and multi-carrier operation for positioning so that communication and positioning is performed over a common set of carriers, e.g., for improving device efficiency and battery life. Alternatively or additionally, with the capability information for multi-carrier positioning, the communication network may advantageously tailor positioning in a way that accounts for the positioning accuracy expected given that capability information.

More particularly, embodiments herein include a method performed by a communication device. The method comprises transmitting, to a network node in a communication network, information about a capability of the communication device to perform a multi-carrier positioning measurement. The method also comprises performing the multi-carrier positioning measurement.

In some embodiments, the multi-carrier positioning measurement is a positioning measurement performed over aggregated carriers, carrier frequencies, positioning resources, or positioning frequency layers that are aggregated in a frequency domain.

In some embodiments, the multi-carrier positioning measurement is a positioning measurement performed over two or more carriers or carrier frequencies aggregated by the communication device in multi-connectivity operation or carrier aggregation operation.

In some embodiments, the information indicates a multi-carrier configuration with which the communication device is capable of performing the multi-carrier positioning measurement.

In some embodiments, the information indicates a multi-carrier configuration that the communication device supports for both performing the multi-carrier positioning measurement and transmitting and/or receiving communication during at least part of a positioning measurement period for performing the multi-carrier positioning measurement. In some embodiments, the multi-carrier configuration is a configuration of at least a set of one or more carriers, carrier frequencies, positioning resources, or positioning frequency layers. In other embodiments, the multi-carrier configuration is a configuration of at least a number of aggregated carriers, aggregated carrier frequencies, aggregated positioning resources, or aggregated positioning frequency layers. In yet other embodiments, the multi-carrier configuration is a configuration of at least an aggregated frequency bandwidth. In still yet other embodiments, the multi-carrier configuration is a configuration of at least a range of aggregated frequency bandwidths. In still yet other embodiments, the multi-carrier configuration is a configuration of at least a bandwidth of aggregated reference signals or aggregated reference signal resources. In still yet other embodiments, the multi-carrier configuration is a configuration of at least a range of bandwidth of aggregated reference signals or aggregated reference signal resources. In still yet other embodiments, the multi-carrier configuration is a configuration of at least a bandwidth of reference signals or reference signal resources of each aggregated carrier, carrier frequency, positioning resource, or positioning frequency layer. In still yet other embodiments, the multi-carrier configuration is a configuration of at least a bandwidth of each aggregated carrier, carrier frequency, positioning resource, or positioning frequency layer. In still yet other embodiments, the multi-carrier configuration is a configuration of at least a frequency relation, and/or a spatial relation, between aggregated carriers, carrier frequencies, positioning resources, or positioning frequency layers. In some embodiments, the information indicates whether the communication device is capable of performing the multi-carrier positioning measurement without restricting or reducing the multi-carrier configuration during a data inactive time period. In some embodiments, the information indicates whether the multi-carrier configuration supported by the communication device for performing the multi-carrier positioning measurement is the same as a multi-carrier configuration supported by the communication device for transmitting and/or receiving communication.

In some embodiments, the communication device is capable of and/or configured for multi-carrier communication on a set of multiple carriers. In some embodiments, the information indicates whether the communication device is capable of performing the multi-carrier positioning measurement on at least the same set of multiple carriers. In other embodiments, the information indicates whether the communication device is capable of performing the multi-carrier positioning measurement on at least a subset of the set of multiple carriers. In yet other embodiments, the information indicates whether the communication device is capable of performing the multi-carrier positioning measurement on at least a different set of multiple carriers.

In some embodiments, the information indicates a set of one or more carriers, carrier frequencies, positioning resources, or positioning frequency layers, or a number of carriers, carrier frequencies, positioning resources, or positioning frequency layers, over which the communication device is capable of performing the multi-carrier positioning measurement.

In some embodiments, the information indicates an aggregated frequency bandwidth, or a range of aggregated frequency bandwidths, over which the communication device is capable of performing the multi-carrier positioning measurement. In some embodiments, the information indicates a bandwidth of each aggregated carrier, carrier frequency, positioning resource, or positioning frequency layer over which the communication device is capable of performing the multi-carrier positioning measurement. In some embodiments, the information indicates a frequency relation, and/or a spatial relation, between aggregated carriers, carrier frequencies, positioning resources, or positioning frequency layersover which the communication device is capable of performing the multi-carrier positioning measurement.

In some embodiments, the information indicates whether the communication device is capable of performing the multi-carrier positioning measurement with measurement gaps. In other embodiments, the information alternatively or additionally indicates whether the communication device is capable of performing the multi-carrier positioning measurement without measurement gaps.

In some embodiments, the information indicates whether the communication device is capable of performing the multi-carrier positioning measurement with measurement gaps while also using multi-carrier operation to transmit and/or receive communication during at least part of a positioning measurement period for performing the multi-carrier positioning measurement.

In some embodiments, the information indicates one or more requirements that the communication device requires for performing the multi-carrier positioning measurement over a positioning measurement period. In some embodiments, the one or more requirements include at least a minimum number of samples required for performing the multi-carrier positioning measurement. In other embodiments, the one or more requirements include at least a minimum length or duration of the positioning measurement period required for performing the multi-carrier positioning measurement. In other embodiments, the one or more requirements include at least a minimum number of receive beam sweeps required for performing the multi-carrier positioning measurement.

In some embodiments, the method further comprises receiving assistance data that assists the communication device to perform the multi-carrier positioning measurement. In some embodiments, the assistance data is received responsive to, or after, transmitting the information. In some embodiments, the method further comprises performing the multi-carrier positioning measurement with assistance of the assistance data.

In some embodiments, the method further comprises performing the multi-carrier positioning measurement. In some embodiments, the method further comprises using a result of the multi-carrier positioning measurement for one or more operational tasks. In some embodiments, the one or more operational tasks include at least reporting the result of the multi-carrier positioning measurement. In other embodiments, the one or more operational tasks include at least determining a position of the communication device. In yet other embodiments, the one or more operational tasks include at least uplink timing synchronization. In still yet other embodiments, the one or more operational tasks include at least synchronization with one or more cells. In still yet other embodiments, the one or more operational tasks include at least propagation delay compensation.

In some embodiments, the network node is a radio network node.

In some embodiments, the information is transmitting via radio resource control, RRC, signaling.

In some embodiments, the network node is a location server.

In some embodiments, the information is transmitted via a Long Term Evolution, LTE, positioning protocol or a New Radio, NR, positioning protocol.

Other embodiments herein include a method performed by a communication device. The method comprises transmitting, to a network node in a communication network, information about a number of carriers or carrier frequencies that the communication device is aggregating, or is expected to aggregate, for transmitting and/or receiving communication.

In some embodiments, the network node is a location server.

In some embodiments, the information is transmitted via a positioning protocol.

In some embodiments, the method further comprises providing user data, and forwarding the user data to a host computer via the transmission to a base station.

Other embodiments herein include a method performed by a network node in a communication network. The method comprises receiving information about a capability of the communication device to perform a multi-carrier positioning measurement. The method also comprises using the information to perform one or more operational tasks.

In some embodiments, the multi-carrier positioning measurement is a positioning measurement performed over aggregated carriers, carrier frequencies, positioning resources, or positioning frequency layers that are aggregated in a frequency domain.

In some embodiments, the multi-carrier positioning measurement is a positioning measurement performed over two or more carriers or carrier frequencies aggregated by the communication device in multi-connectivity operation or carrier aggregation operation.

In some embodiments, the information indicates a multi-carrier configuration with which the communication device is capable of performing the multi-carrier positioning measurement.

In some embodiments, the information indicates a multi-carrier configuration that the communication device supports for both performing the multi-carrier positioning measurement and transmitting and/or receiving communication during at least part of a positioning measurement period for performing the multi-carrier positioning measurement. In some embodiments, the multi-carrier configuration is a configuration of at least a set of one or more carriers, carrier frequencies, positioning resources, or positioning frequency layers. In other embodiments, the multi-carrier configuration is a configuration of at least a number of aggregated carriers, aggregated carrier frequencies, aggregated positioning resources, or aggregated positioning frequency layers. In yet other embodiments, the multi-carrier configuration is a configuration of at least an aggregated frequency bandwidth. In still yet other embodiments, the multi-carrier configuration is a configuration of at least a range of aggregated frequency bandwidths. In still yet other embodiments, the multi-carrier configuration is a configuration of at least a bandwidth of aggregated reference signals or aggregated reference signal resources. In still yet other embodiments, the multi-carrier configuration is a configuration of at least a range of bandwidth of aggregated reference signals or aggregated reference signal resources. In still yet other embodiments, the multi-carrier configuration is a configuration of at least a bandwidth of reference signals or reference signal resources of each aggregated carrier, carrier frequency, positioning resource, or positioning frequency layer. In still yet other embodiments, the multi-carrier configuration is a configuration of at least a bandwidth of each aggregated carrier, carrier frequency, positioning resource, or positioning frequency layer. In still yet other embodiments, the multi-carrier configuration is a configuration of at least a frequency relation, and/or a spatial relation, between aggregated carriers, carrier frequencies, positioning resources, or positioning frequency layers. In some embodiments, the information indicates whether the communication device is capable of performing the multi-carrier positioning measurement without restricting or reducing the multi-carrier configuration during a data inactive time period. In some embodiments, the information indicates whether the multi-carrier configuration supported by the communication device for performing the multi-carrier positioning measurement is the same as a multi-carrier configuration supported by the communication device for transmitting and/or receiving communication.

In some embodiments, the communication device is capable of and/or configured for multi-carrier communication on a set of multiple carriers. In some embodiments, the information indicates whether the communication device is capable of performing the multi-carrier positioning measurement on the same set of multiple carriers. In other embodiments, the information indicates whether the communication device is capable of performing the multi-carrier positioning measurement on a subset of the set of multiple carriers. In yet other embodiments, the information indicates whether the communication device is capable of performing the multi-carrier positioning measurement on a different set of multiple carriers.

In some embodiments, the information indicates a set of one or more carriers, carrier frequencies, positioning resources, or positioning frequency layers, or a number of carriers, carrier frequencies, positioning resources, or positioning frequency layers, over which the communication device is capable of performing the multi-carrier positioning measurement.

In some embodiments, the information indicates an aggregated frequency bandwidth, or a range of aggregated frequency bandwidths, over which the communication device is capable of performing the multi-carrier positioning measurement. In other embodiments, the information alternatively or additionally indicates a bandwidth of each aggregated carrier, carrier frequency, positioning resource, or positioning frequency layer over which the communication device is capable of performing the multi-carrier positioning measurement. In yet other embodiments, the information alternatively or additionally indicates a frequency relation, and/or a spatial relation, between aggregated carriers, carrier frequencies, positioning resources, or positioning frequency layers over which the communication device is capable of performing the multi-carrier positioning measurement.

In some embodiments, the information indicates whether the communication device is capable of performing the multi-carrier positioning measurement with measurement gaps. In other embodiments, the information alternatively of additionally indicates whether the communication device is capable of performing the multi-carrier positioning measurement without measurement gaps.

In some embodiments, the information indicates whether the communication device is capable of performing the multi-carrier positioning measurement with measurement gaps while also using multi-carrier operation to transmit and/or receive communication during at least part of a positioning measurement period for performing the multi-carrier positioning measurement.

In some embodiments, the information indicates one or more requirements that the communication device requires for performing the multi-carrier positioning measurement over a positioning measurement period. In some embodiments, the one or more requirements include at least a minimum number of samples required for performing the multi-carrier positioning measurement. In other embodiments, the one or more requirements include at least a minimum length or duration of the positioning measurement period required for performing the multi-carrier positioning measurement. In yet other embodiments, the one or more requirements include at least a minimum number of receive beam sweeps required for performing the multi-carrier positioning measurement.

In some embodiments, the method further comprises transmitting, to the communication device, assistance data that assists the communication device to perform the multi-carrier positioning measurement. In some embodiments, the assistance data is transmitted responsive to, or after, receiving the information. In some embodiments, the method further comprises receiving a result of the multi-carrier positioning measurement performed with assistance of the assistance data.

In some embodiments, the method further comprises receiving a result of the multi-carrier positioning measurement as performed by the communication device.

In some embodiments, the one or more operational tasks include determining a position of the communication device. In other embodiments, the one or more operational tasks include adapting a multi-carrier configuration of the communication device for multi-carrier communication. In yet other embodiments, the one or more operational tasks include prohibiting or allowing the communication device to perform the multi-carrier positioning measurement. In still yet other embodiments, the one or more operational tasks include configuring, reconfiguring, or deconfiguring the communication device with a measurement gap pattern.

In some embodiments, the network node is a radio network node.

In some embodiments, the information is received from the communication device and/or is received via radio resource control, RRC, signaling.

In some embodiments, the network node is a location server.

In some embodiments, the information is received from a radio network node and/or is received via a Long Term Evolution, LTE, positioning protocol or a New Radio, NR, positioning protocol.

Other embodiments herein include a method performed by a network node in a communication network. The method comprises transmitting or receiving information about a number of carriers or carrier frequencies over which a communication device is or is expected to perform multi-carrier communication.

In some embodiments, multi-carrier communication comprises the communication device aggregating carriers or carrier frequencies for transmitting and/or receiving communication.

In some embodiments, transmitting or receiving comprises transmitting the information to another network node.

In some embodiments, the network node is a radio network node and wherein the another network node is a location server.

Embodiments herein also include corresponding apparatus, computer programs, and carriers of those computer programs.

### BRIEF DESCRIPTION OF THE DRAWINGS

FIG. 1 is a block diagram of a communication network and communication device according to some embodiments.

FIG. 2 is a block diagram of an NR positioning architecture according to some embodiments.

FIG. 3 shows an example of a measurement gap pattern (MGP) in accordance with some embodiments.

FIG. 4 shows an example of Location Management Function (LMF) receiving information from a gNB according to some embodiments.

FIG. 5 shows an UL carrier aggregation signaling example according to some embodiments.

FIG. 6 shows for example a set of carriers commonly configured for communication and MC positioning according to some embodiments.

FIG. 7 depicts a method performed by a communication device in accordance with particular embodiments.

FIG. 8 depicts a method performed by a communication device in accordance with other particular embodiments.

FIG. 9 depicts a method performed by a network node in a communication network in accordance with particular embodiments.

FIG. 10 depicts a method performed by a network node in a communication network 10 in accordance with other particular embodiments.

FIG. 11 is a block diagram of a communication device according to some embodiments.

FIG. 12 is a block diagram of a network node according to some embodiments.

FIG. 13 shows an example of a communication system in accordance with some embodiments.

FIG. 14 is a block diagram of a host which may be an embodiment of the host of FIG. 13, in accordance with various aspects described herein.

FIG. 15 shows a communication diagram of a host communicating via a network node with a UE over a partially wireless connection in accordance with some embodiments.

### DETAILED DESCRIPTION

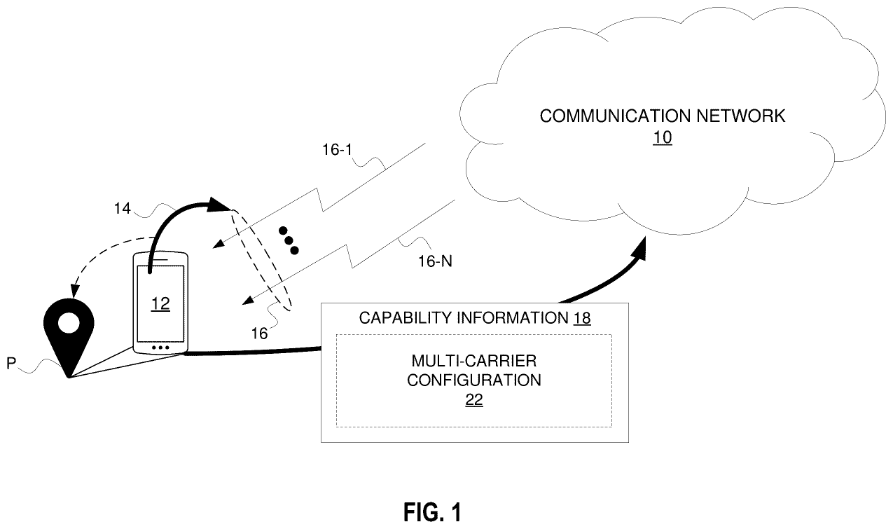

FIG. 1 shows a communication network 10 configured to provide communication service to a communication device 12, e.g., in the form of a user equipment (UE). The communication device 12 as shown is configured to perform a positioning measurement 14 that is usable by the communication device 12 or the communication network 10 for determining a geographical position P of the communication device 12.

In some embodiments, the communication device 12 in this regard is capable of performing the positioning measurement 14 over two or more aggregated carriers 16-1 . . . 16-N, generally referred to as aggregated carriers 16. The carriers 16 may be aggregated for example in multi-connectivity operation or carrier aggregation operation. Regardless, when the positioning measurement 14 is performed over two or more aggregated carriers 16, the positioning measurement 14 may be referred to as a multi-carrier positioning measurement. Performing a multi-carrier positioning measurement may involve, for example, measuring positioning reference signals received on respective carriers 16-1 . . . 16-N and then combining or aggregating the results of those positioning reference signal measurements into a positioning measurement result, e.g., by summing or averaging the positioning reference signal measurement results across the carriers 16. As another example, performing a multi-carrier positioning measurement may involve performing different types of positioning measurements on respective carriers 16-1 . . . 16-N and then combining or aggregating the results of those different types of positioning measurements into a single positioning measurement result.

In this context, the communication device 12 as shown is configured to transmit capability information 18 to the communication network 10. The capability information 18 includes information about a capability of the communication device 12 to perform a multi-carrier positioning measurement 14. Such information may characterize whether the communication device 12 has the capability to perform a multi-carrier positioning measurement 14 and/or how the communication device 12 is capable of performing a multi-carrier positioning measurement 14.

The capability information 18 may for example include information about whether or not the communication device 12 has the capability to perform a multi-carrier positioning measurement 14. Alternatively or additionally, the capability information 18 may include information indicating a multi-carrier configuration 22. The multi-carrier configuration 22 may for instance be a multi-carrier positioning measurement configuration with which the communication device 12 is capable of performing the multi-carrier positioning measurement 14. Or, even further, the multi-carrier configuration 22 may be a multi-carrier configuration that the communication device 12 supports for both multi-carrier positioning and multi-carrier communication, i.e., a configuration that the communication device 12 supports for both performing the multi-carrier positioning measurement 14 and transmitting and/or receiving communication during at least part of a positioning measurement period for performing the multi-carrier positioning measurement 14.

In some embodiments, the multi-carrier configuration 22 may for instance be a configuration of one or more of: a set of one or more carriers or carrier frequencies; a number of aggregated carriers or aggregated carrier frequencies; an aggregated frequency bandwidth; a range of aggregated frequency bandwidths; a bandwidth of aggregated reference signals or aggregated reference signal resources; a range of bandwidth of aggregated reference signals or aggregated reference signal resources; a bandwidth of reference signals or reference signal resources of each aggregated carrier or carrier frequency; a bandwidth of each aggregated carrier or carrier frequency; and/or a frequency relation, and/or a spatial relation, between aggregated carriers or carrier frequencies.

Regardless of the exact nature of the capability information 18, though, the communication network 10 in some embodiments uses the capability information 18 for one or more operational tasks. For example, equipped with the capability information 18 for multi-carrier positioning, the communication network 10 may advantageously adapt and/or otherwise coordinate configuration of the communication device 12 with multi-carrier operation for communication. The communication network 10 may for example coordinate multi-carrier operation for communication and multi-carrier operation for positioning so that communication and positioning is performed over a common set of carriers, e.g., for improving device efficiency and battery life. Alternatively or additionally, with the capability information 18 for multi-carrier positioning, the communication network 10 may advantageously tailor positioning in a way that accounts for the positioning accuracy expected given that capability information 18.

Generally, then, the communication network 10 may use the capability information 18 for one or more operational tasks that include determining a position of the communication device 12, adapting a multi-carrier configuration of the communication device 12 for multi-carrier communication, prohibiting or allowing the communication device 12 to perform the multi-carrier positioning measurement, and/or configuring or deconfiguring the communication device 12 with a measurement gap pattern.

Note, too, that although FIG. 1 shows the communication device 12 as transmitting the capability information 18 to the communication network 10 generally, the communication device 12 may transmit the capability information 18 to any node in the communication network 10, at any protocol layer. In one embodiment, for example, the communication device 12 transmits the capability information 18 to a network node, where the network node may be a radio network node (e.g., base station) or a location server (e.g., implementing a Location Management Function, LMF).

Note that, although the term multi-carrier positioning measurement 14 is used for describing some embodiments herein, the multi-carrier positioning measurement 14 may alternatively be referred to as a bandwidth aggregated positioning measurement, a combined or composite positioning measurement, a wideband positioning measurement, a multi-resource positioning measurement, or a multi-layer positioning measurement, or any other term that characterizes the positioning measurement 14 as being aggregated in the frequency domain, e.g., across carriers, carrier frequencies, positioning resources, or positioning frequency layers.

The aggregated carriers 16 in this regard may alternatively represent aggregated carrier frequencies, aggregated positioning resources, or aggregated positioning frequency layers that are aggregated in the frequency domain.

Some embodiments herein are applicable in the following context where the communication device 12 is exemplified as a user equipment (UE).

### Multicarrier Operation

Some embodiments herein are applicable to multicarrier operation as described below. In multicarrier (MC) operation, the UE can operate on multiple carriers for communication e.g., for receiving and/or transmitting signals between the UE and one or more base stations. Examples of MC operations are carrier aggregation (CA), dual connectivity (DC), multi-connectivity (MuC), etc. The carrier frequency is also called as component carrier (CC), frequency layer, serving carrier, frequency channel, etc.

A UE may be configured with one or more serving cells. Examples of serving cells are special cell (SpCell), secondary cell (SCell), etc. Examples of SpCell are primary cell (PCell), primary secondary cell (PSCell), etc. The carrier frequencies of SpCell, SCell, PCell and PSCell are called as special CC (SpCC) or simply SpC, secondary CC (SCC), primary CC (PCC) and primary secondary CC (PSCC) or simply PSC, respectively.

In CA, the UE has one primary serving cell (called PCell) and one or more secondary serving cells (SCells). The PCell is considered more important and for example some control signaling is handled via the PCell.

MuC comprises of two or more cell groups (CG). DC, which is special case of MuC, comprises of 2 CGs: a master cell group (MCG) which contains at least a PCell and a secondary cell group (SCG). Each of MCG and SCG may further contain one or more SCells. The PCell manages (e.g., configures, changes, release, etc.) all SCells in MCG and PSCell in SCG. PSCell manages all SCells in SCG. The cells in MCG and SCG may belong to the same radio access technology (RAT) (e.g., all cells are New Radio (NR) in both MCG and SCG like in NR-DC) or they may belong to different RATs (e.g., Long Term Evolution (LTE) cells in MCG and NR cells in SCG like in E-UTRA-NR DC (EN-DC) or NR cells in MCG and LTE cells in SCG like in NR-E-UTRA DC (NE-DC)).

In addition, the concept of “configuration” of cells, the concept of “activation” has been introduced for SCells or PSCell (not for the PCell). Cells may be configured (or deconfigured) using Radio Resource Control (RRC) signaling, which can be slow, and PSCell and SCells can be activated (or deactivated) using a Medium Access Control (MAC) control element, which is faster.

The CCs in MC configuration may belong to the same frequency band (e.g., intra-band MC), or they may belong to different frequency bands (e.g., inter-band MC), or combination thereof (e.g., some CCs are in the same frequency band while other CCs are in different frequency bands), etc. The CCs may also belong to the same frequency range (FR) (e.g., all in FR1 or all in FR2), or they may belong to different FRs (e.g., some CCs in FR1 while others in FR2).

### Positioning in NR

Some embodiments herein are applicable for positioning in New Radio (NR).

### Architecture

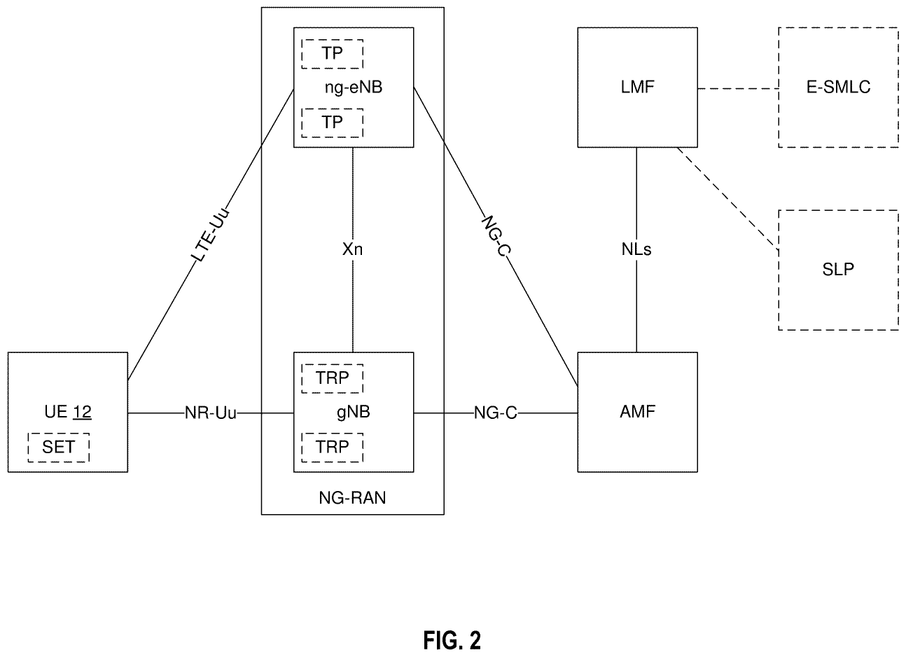

Positioning in NR is supported by the architecture shown in FIG. 2. The interactions between the gNodeB and the device (UE) 12 is supported via the Radio Resource Control (RRC) protocol, while the location node interfaces with the UE 12 via the LTE positioning protocol (LPP). LPP is a common protocol to both NR and LTE. The Location Management Function (LMF) is the location node in NR. There are also interactions between the location node and the gNodeB via the NR Positioning Protocol a (NRPPa) protocol.

In comparison to LTE, NR positioning benefits from larger bandwidth and finer beamforming and can localize a user equipment (UE) with higher accuracy and supports the following positioning methods: Downlink Time Difference of Arrival (DL-TDoA), Uplink Relative Time of Arrival (UL-RToA), Downlink Angle of Departure (DL-AoD), Uplink Angle of Arrival (UL-AoA), including Azimuth of arrival and Zenith of arrival, Multi-Round Trip Time (RTT) positioning, and NR Enhanced Cell ID.

### NR UE Positioning Measurements

Some embodiments herein support the following NR positioning measurements performed by the UE.

One NR positioning measurement is Reference Signal Time Difference (RSTD). RSTD is reference signal time difference between the positioning node j and the reference positioning node i. It is measured on the DL PRS signals and always involves two cells (cell is interchangeably called as transmission reception point, TRP).

Another NR positioning measurement is Positioning Reference Signal (PRS) Reference Signal Received Power (PRS-RSRP). PRS-RSRP is the linear average over the power contributions (in [W]) of the resource elements that carry downlink (DL) PRS reference signals.

Yet another NR positioning measurement is PRS-RSRPP, which stands for DL PRS reference signal received path power (DL PRS-RSRPP). It is defined as the power of the linear average of the channel response at the i-th path delay of the resource elements that carry DL PRS signal configured for the measurement, where DL PRS-RSRPP for the 1st path delay is the power contribution corresponding to the first detected path in time.

Another NR positioning measurement is UE Rx-Tx time difference. It is defined as:

$${T}_{UE - RX} - {T}_{UE - TX}$$

T_{UE-RX} is the UE received timing of downlink subframe #i from a positioning node, defined by the first detected path in time. It is measured on PRS signals received from the gNB. T_{UE-TX} is the UE transmit timing of uplink subframe #j that is closest in time to the subframe #i received from the positioning node. It is measured on SRS signals transmitted by the UE.

The UE Rx-Tx time difference is an example of a bidirectional timing measurement. More generally it is called as round trip time (RTT).

The UE can be configured to measure one or multiple types of positioning measurements on one or multiple cells.

### Reference Signals for NR RTT Positioning Measurements

Some embodiments herein are applicable for multi-carrier positioning measurements performed on one or more of the following reference signals.

### Positioning Reference Signal

Positioning reference signal (PRS) are periodically transmitted on a positioning frequency layer in PRS resources in the DL by the gNB. The information about the PRS resources is signaled to the UE by the positioning node via higher layers but may also be provided by base station e.g., via broadcast. Each positioning frequency layer comprises PRS resource sets, where each PRS resource set comprises one or more PRS resources. All the DL PRS resources within one PRS resource set are configured with the same periodicity. The PRS resource periodicity (Tₚₑᵣ^{PRS}) comprises:

$${T}_{per}^{PRS} ∈ {2}^{μ} \{ 4 , 8 , 16 , 32 , 64 , 5 , 10 , 20 , 40 , 80 , 160 , 320 , 640 , 1280 , 2560 , 5120 , 10240 , 20480 \}$$

slots, where μ=0, 1, 2, 3 for PRS SCS of 15, 30, 60 and 120 KHz respectively.

$${T}_{per}^{PRS} = {2}^{μ} \cdot 20480$$

is not supported for μ=0.

Each PRS resource can also be repeated within one PRS resource set and takes values

$${T}_{rep}^{PRS} ∈ \{ 1 , 2 , 4 , 6 , 8 , 16 , 32 \} .$$

PRS are transmitted in consecutive number of symbols (L_{PRS}) within a slot: L_{PRS}∈{2, 4, 6, 12}. The following DL PRS resource element (RE) patterns, with comb size K_{PRS} equal to number of symbols L_{PRS} are supported:
Comb-2: Symbols {0, 1} have relative RE offsets {0, 1}
Comb-4: Symbols {0, 1, 2, 3} have relative RE offsets {0, 2, 1, 3}
Comb-6: Symbols {0, 1, 2, 3, 4, 5} have relative RE offsets {0, 3, 1, 4, 2, 5}
Comb-12: Symbols {0, 1, 2, 3, 4, 5, 6, 7, 8, 9, 10, 11} have relative RE offsets {0, 6, 3, 9, 1, 7, 4, 10, 2, 8, 5, 11}

In some embodiments, the maximum PRS bandwidth (BW) is 272 physical resource blocks (PRBs). In some embodiments, the minimum PRS BW is 24 PRBs. In some embodiments, the configured PRS BW is always a multiple of 4.

In general, PRS resource sets may comprise parameters such as subcarrier spacing (SCS), PRS BW, PRS resource set periodicity and slot offset with respect to reference time (e.g., SFN #0, slot #0), PRS resource repetition factor (e.g., number of times PRS resource repeated in a PRS resource set), PRS symbols in PRS resource, PRS resource time gap (e.g., number of slots between successive repetitions), PRS muting pattern, etc.

### Sounding Reference Signal (SRS)

In some embodiments, multi-carrier positioning measurements may be performed on SRS. In these embodiments, for positioning timing measurements (e.g., UE Rx-Tx, gNB, Rx-Tx, UL RTOA, etc.), the UE is configured with SRS for uplink transmission. The SRS comprises one or more SRS resource sets and each SRS resource set comprises one or more SRS resources. Each SRS resource comprises one or more symbols carrying SRS with certain SRS bandwidth. There can be periodic SRS, aperiodic SRS, and semi-persistent SRS transmissions—any of them can also be used for positioning measurements. There are two options for SRS configuration for positioning:

In one example, the UE can be configured with SRS resource set(s) where each SRS resource occupies N_{S}∈{1, 2, 4} adjacent symbols within a slot. In this case, SRS antenna switching is supported. Each symbol can also be repeated with repetition factor R∈{1,2,4}, where R≤N_{S}. The periodic SRS resource can be configured with certain periodicity (T_{SRS}) e.g.

$${T}_{SRS} ∈ \text{} \{ 1 , 2 , 4 , 5 , 8 , 10 , 16 , 20 , 32 , 40 , 64 , 80 , 160 , 320 , 640 , 1280 , 2560 \} slots .$$

In another example, the UE can be configured with SRS positioning specific resource set(s) (SRS-PosResourceSet). In this case each SRS positioning resource (SRS-PosResource) occupies N_{S}∈{1, 2, 4, 8, 12} adjacent symbols within a slot. In this case, SRS antenna switching is not supported.

In both options, the UE can be configured with 1, 2 or 4 antenna ports for transmitting each SRS resource within an SRS resource set. The default value is one SRS antenna port for each SRS resource.

### Bandwidth Aggregation for Positioning

Some embodiments herein are applicable for bandwidth aggregation for positioning as described below.

For high accuracy timing/ranging measurement, higher bandwidth is preferred to support use cases that demand stringent requirements on positioning accuracy. To support positioning use cases, NR PRS can be configured to occupy up to 100 MHz of bandwidth in FR1 and 400 MHz of bandwidth in FR2. Since the bandwidth that can be allocated to PRS/SRS is limited, to further increase the accuracy of timing/ranging measurements, some embodiments herein support bandwidth aggregation for positioning. Some embodiments herein ensure joint/coherent processing of PRS resources received from different carriers/PFLs for positioning measurements.

### Measurement Gap

The multi-carrier positioning measurement 14 herein may or may not use measurement gaps as descried herein.

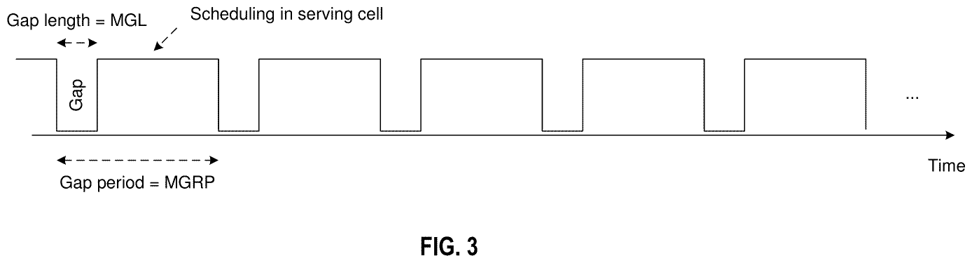

In some embodiments, a measurement gap pattern (MGP) is used by the UE for performing measurements on cells of the serving carrier (e.g., intra-frequency carrier), non-serving carriers (e.g., inter-frequency carrier, inter-RAT carriers, etc.), positioning frequency layer (PFL), etc. In NR, gaps are used for measurements on cells of the serving carrier in some scenarios e.g., if the measured signals (e.g., Synchronization Signal Block, SSB) are outside the bandwidth part (BWP) of the serving cell. The UE is scheduled in the serving cell only within the BWP. During the gap, the UE cannot be scheduled for receiving/transmitting signals in the serving cell. Therefore, during the gap, the UE does not receive or transmit signals in the serving cell except the reception of signals (e.g., reference signals) for measurements. A measurement gap pattern is characterized or defined by several parameters: measurement gap length (MGL), measurement gap repetition period (MGRP), measurement gap time offset (MGTO) wrt reference time (e.g., slot offset wrt serving cell's system frame number (SFN) such as SFN=0), measurement gap timing advance (MGTA), etc. An example of MGP is shown in FIG. 3. As an example, MGL can be 1.5, 3, 3.5, 4, 5.5, 6 ms, 10 ms, 20 ms, etc., and MGRP can be 20, 40, 80, 160, 320, 640, 1280, 2560 ms, etc. Longer MGRP such as 320 ms or longer is typically used for multi-SIM operation e.g., for measurements on carrier in idle/inactive state, wherein SIM stands for Subscriber Identity Module. The MGP is configured by the network node and is also called a network controlled or network configurable MGP. Therefore, the serving base station is fully aware of the timing of each gap within the MGP.

In some embodiments, measurements on cells of carriers configured for multicarrier operation (e.g., CA for communication) do not require a gap. The capability information 18 herein may include information about the UE capability to aggregate a number of carriers for positioning when the UE is involved in CA for communication.

A secondary component carrier (CC) may be dynamically activated and deactivated for communication purposes. Some embodiments herein recognize that how many CCs are configured for communication may have an impact on the UE capability to aggregate carriers for positioning.

Some embodiments herein inform the Location Management Function (LMF) about the number of CCs configured to the UE. The LMF may exploit this information in order to configure an optimum number of carriers that the UE may combine for a positioning measurement.

The capability information 18 in some embodiments includes information about the UE capability to aggregate PRS resources from different carriers/PFLs for positioning measurements.

According to some embodiments herein, assistance data for the UE includes information on PRS resources on different PFLs that the UE can combine to perform positioning measurements.

Some embodiments herein are applicable to a scenario where a UE is served by at least a first cell (Cell1), which is managed or served or controlled by a first network node (NW1) (e.g., a base station). The UE can further be configured by a second network node (NW2) (e.g., location server such as LMF) for performing a positioning measurement on two or more aggregated carriers.

According to a first embodiment, the UE determines or obtains its capability related to a multicarrier carrier (MC) positioning measurement (or simply called MC positioning) and transmits the information about the determined MC positioning measurement capability to one or more network nodes (e.g., to NW2 such as location server, to NW1 such as base station, etc.). This information about the determined MC positioning measurement capability is an example of the capability information 18 in FIG. 1. The UE may transmit the information to the network node as part of a capability message and/or as part of the UE assistance information (e.g., based on current or expected status of the MC capability which may change over time). In response, the UE may further receive assistance data from NW2 for performing a MC positioning measurement and use the received assistance data for performing the MC positioning measurement.

According to a second embodiment, NW1 serving the UE obtains information related to one or more parameters or aspects of the MC positioning capability of the UE and uses the obtained information for performing one or more operational tasks. Here, the information related to one or more parameters or aspects of the MC positioning capability exemplifies the capability information 18 in FIG. 1. NW1 may obtain the information related to one or more parameters or aspects of the MC positioning capability of the UE by receiving it from the UE, from another network node (e.g., NW2) or based on statistics or historical data.

According to another aspect of the second embodiment, NW1 serving the UE may inform NW2 of information related to the MC configuration configured or expected to be configured at the UE for communication purposes. The information related to the MC configuration exemplifies the capability information 18 in FIG. 1.

According to a third embodiment, NW2 obtains information related to one or more parameters or aspects of the MC positioning capability of the UE and uses the obtained information for performing one or more operational tasks. NW2 may obtain the information related to one or more parameters or aspects of the MC positioning capability of the UE by receiving it from the UE, from another network node (e.g., NW1) or based on statistics or historical data. The information related to the MC configuration exemplifies the capability information 18 in FIG. 1.

The MC positioning capability may be static (e.g., based on UE hardware and/or architecture capability) or change over time in a semi-static or dynamic manner (e.g., based on change on resources, etc.). The MC positioning capability may also be called UE assistance information (UAI). For example, the MC positioning capability may further change over time based on one or more of factors or scenarios such as number of carriers configured for MC operation for communication and/or a type of configured MC operation for communication (e.g., intra-band CA, inter-band CA), etc.

Generally, then, some embodiments herein enable the network to know the UE capability to aggregate bandwidth for positioning. In other words, UE capability to aggregate positioning resources transmitted in different carriers/PFLs is known to the network.

Based on UE capability, the network may configure a UE with a number of carriers it may aggregate for positioning measurement during a positioning procedure.

According to some embodiments, the network alternatively or additionally knows what accuracy should be expected based on the UE capability on the number of carriers it can aggregate during a given positioning procedure.

Alternatively or additionally, the network in some embodiments can identify a set of common component carriers that could be used for both communication and positioning which may reduce UE complexity/effort.

Certain embodiments may provide one or more of the following technical advantage(s). Some embodiments herein enhance the accuracy of a positioning measurement. Alternatively or additionally, some embodiments herein enable the UE to optimize the available resources for performing BW aggregated positioning measurement and MC operation for communication. Alternatively or additionally, some embodiments herein enable the UE to conserve its battery power. Alternatively or additionally, some embodiments herein avoid or minimize degradation of the positioning measurements while configured to perform the BW aggregated positioning measurement. Alternatively or additionally, if there is already (ongoing) carrier aggregation for enhancing DL/UL data throughput, then some embodiments herein enable the network (NW) to prioritize the same carrier aggregation configuration for DL-PRS/UL-SRS. Alternatively or additionally, some embodiments herein make it to where a UE would not have to simultaneously keep track (synchronize) with the aggregated carriers for communication and positioning separately. Rather, the NW may strive to provide a common configuration.

### Example Scenario Description

Some embodiments herein are applicable to the following example scenario. The scenario comprises a UE served by at least a first cell (cell1) which is managed or served by a first network node (NW1) (e.g., base station). The UE may also be served by more than one cell (e.g., cell1, cell2, etc.) in multicarrier operation such as in carrier aggregation (CA), multi-connectivity, dual connectivity (DC), etc. Examples of serving cells are special cell (SpCell), secondary cell (SCell), etc. Examples of sPCell are PCell, PSCell, etc.

The UE is configured by a second network node (NW2) (e.g., by LMF, by NW1 such as the base station or gNB, etc.) to perform at least one positioning measurement (e.g., RSTD, UE Rx-Tx time difference, PRS-RSRP, PRS-RSRPP, etc.) on signals operating between the UE and one or more radio nodes (e.g., TRPs). Examples of signals are PRS, SRS, CS-RS, tracking radio signals, signals (e.g., Primary Synchronization Signal (PSS), Secondary Synchronization Signal (SSS), etc.) in SSB, etc. The UE may be configured to perform the positioning measurement by receiving assistance data or measurement configuration from the network node by higher layer signaling e.g., from the location server (e.g., LMF) via LTE Positioning Protocol (LPP) signaling, from the base station (e.g., gNB) via Radio Resource Control (RRC) signaling, etc. The term operating a signal may refer to any one or more of the following: transmission of the signals by the UE to a network node (e.g., to the TRP such as SRS); reception of the signal at the UE from a network node (e.g., from the TRP such as PRS, CSI, etc.); transmission of the signals by a network node (e.g., TRP) (e.g., to the UE such as PRS, CSI-RS, etc.); or reception of the signal at a network node (e.g., TRP) (e.g., from the UE such as SRS, etc.).

In some embodiments, the UE is configured to operate in an RRC activity state while performing a positioning measurement. In one example, the UE may be configured to operate in low activity RRC state. In another example, the UE may be configured to operate in high activity RRC state, etc. In low activity RRC state the UE may typically be configured to operate using a discontinuous reception (DRX) cycle which is equal to or larger than a certain threshold, e.g., 320 ms or longer. In low activity RRC state, the UE may further be configured with extended DRX cycle (eDRX). In high activity RRC state, the UE may or may not be configured to operate with a DRX cycle or eDRX cycle or may be configured with any DRX cycle or with any eDRX cycle when configured. Examples of low activity RRC state are RRC idle state, RRC inactive state, etc. An example of high activity RRC state is RRC connected state, etc.

Note that the term carrier frequency is also called as component carrier (CC), frequency layer, layer, carrier, frequency, serving carrier, frequency channel, positioning frequency layer (PFL), etc. The carrier frequency belongs to certain frequency band, which may contain one or multiple carrier frequencies based on its passband (e.g., size of the band in frequency domain) and/or bandwidth of the carriers and/or the channel raster, etc. In some embodiments, the carrier frequency related information is transmitted to the UE by a network node using a channel number or identifier via message e.g., RRC. Examples of the channel number or identifier, which may be pre-defined, are absolute radio frequency channel number (ARFCN), NR-ARFCN, etc.

The carrier frequencies on which the UE is configured to perform a positioning measurement may belong to a certain frequency range (FR). Examples of FR are within frequency range 1 (FR1), within frequency range 2 (FR2), within frequency range 3 (FR3), etc. In one example, frequencies within FR2 are frequencies above a certain threshold e.g., 24 GHz or higher. In another example, the frequencies in FR2 may vary between 24 GHz to 52.6 GHz. In another example, frequencies in FR2 may vary between 24 GHz to 71 GHz. Frequencies in FR1 are below the frequencies in FR2. In one example, frequencies in FR1 range between 410 MHz and 7125 MHz. In higher frequencies (e.g., mmwave, FR2, FR3, etc.) due to higher signal dispersion, the transmitted signals are beamformed by a base station e.g., transmitted in terms of SSB beams. The beam-based transmission and/or reception may also be used in lower frequencies e.g., in FR1. The UE creates a receive (RX) beam at its receiver to receive the signal (e.g., PRS, SSB, CSI-RS, etc.). A DL RS (e.g., PRS, SSB, CSI-RS, etc.) may therefore interchangeably be called as a DL beam, spatial filter, spatial domain transmission filter, main lobe of the radiation pattern of antenna array, etc. The term beam used herein may refer to RS such as PRS, SSB, Channel State Information (CSI) Reference Signal (CSI-RS), etc. The RS or beams may be addressed or configured by an identifier, which can indicate the location of the beam in time in a beam pattern e.g., beam index such as PRS index indicate PRS beam location in the pre-defined PRS format/pattern, beam index such as SSB index indicate SSB beam location in the pre-defined SSB format/pattern, etc. The measurement on such RS may also be called as beam measurement or beam-based measurement. The UE may also combine two or more beam measurements to obtain a combine or overall measurement result.

A transmission reception point (TRP) may be a radio node e.g., base station, a node transmitting radio signals (e.g., PRS) and/or receiving radio signals (e.g., SRS), which can be used for positioning measurements performed by the UE and/or by the radio node itself.

The positioning measurements may be performed by the UE for one or more purposes or applications or use cases, etc. Examples of purpose are positioning, enhancing the synchronization between the UE and a radio node (e.g., BS) or another UE, propagation delay compensation, etc.

### Embodiment 1: UE Adaptive Capability to Aggregate Carriers for Positioning

In one of the embodiments, the UE determines or obtains its capability related to a multicarrier carrier (MC) positioning measurement (or simply called MC positioning) and transmits the information about the determined MC positioning measurement capability to a network node (e.g., location server, base station, etc.). The UE may determine or obtain its MC positioning capability by retrieving it from its memory and/or based on available resources and/or based on MC configuration used or supported for communication.

The UE may also determine or obtain its MC positioning capability by comparing the received positioning assistance data from NW1 (e.g., LMF), which may consist of positioning signal configuration corresponding to different carrier frequencies for the same TRP, with the MC configuration for communication (carrier aggregation configuration) from NW2 (a UE serving gNB). Based on the comparison, the UE determines what positioning reference signals (PRS) configuration from the assistance data corresponds to its CA configuration, and consequently reports which of the positioning reference signals it is capable to perform aggregated measurements on.

The term MC operation for communication (or simply MC communication) refers to the UE configured to operate at least two carriers (e.g., two CCs) for operating signals (e.g., receive and/or transmit) for communication between the UE and two or more serving cells (e.g., PCell, SCell, PSCell, etc.). Examples of communication signals are data and/or control channels. Examples of DL communication signals received by the UE from a serving cell are DL control channel such as Physical Downlink Control Channel (PDCCH), DL data channel such as Physical Downlink Shared Channel (PDSCH), etc. Examples of UL communication signals transmitted by the UE to a serving cell are UL control channel as Physical Uplink Control Channel (PUCCH), UL data channel such as Physical Uplink Shared Channel (PUSCH), etc.

### MC Positioning Measurement Characteristics:

The term MC positioning measurement may interchangeably be called a bandwidth aggregated positioning measurement, combined or composite positioning measurement, wideband positioning measurement, etc.

In some embodiments, the MC positioning measurement capability (or simply MC positioning capability) refers to a capability of the UE to perform at least one type of positioning measurement over at least two aggregated carrier frequencies (e.g., two or more PFLs) in a frequency domain. For example, the UE combines or aggregate reference signals (e.g., PRS, SRS, etc.) operating on at least two different carriers for performing one positioning measurement. For example, the UE obtains one or more positioning measurement samples or snapshots on at least two carriers, which are configured for the aggregated positioning measurement. The UE further combines (based on a function, e.g., average, sum, etc.) multiple positioning measurement samples or snapshots over a measurement period for obtaining the positioning measurement results. The positioning measurement performed on the aggregated carriers enhances the positioning measurement accuracy, which in turn further enhances the location estimation of the UE.

The MC positioning measurement may be associated with or characterized by one or more of the following features or characteristics.

In one example, the UE may combine reference signals used for positioning measurements (e.g., PRS resources) from at least two different carriers/PFLs for performing one type of positioning measurement (e.g., one RSTD measurement).

In another example, the UE may combine reference signals used for positioning measurements (e.g., PRS resources) from at least two different carriers/PFLs for performing two or more different types of positioning measurement (e.g., one RSTD measurement, one UE Rx-Tx measurement).

In another example, the MC positioning measurement is performed by the UE on carriers operated by the same node (e.g., same base station, TRP, etc.).

In another example, the MC positioning measurement is performed by the UE on carriers operated by different nodes (e.g., different base stations, TRP, etc.).

In another example, the MC positioning measurement is performed by the UE on carriers operated by different nodes, by receiving the carriers in parallel according to its MC capability, but without combining the measurements to expand the bandwidth. In this example, the measurement can be an RSTD or a UE Rx Tx measurement where the time differences is between the two CCs from two different TRPs.

In another example, the MC positioning measurement is performed by the UE on carriers belonging to the same frequency band. This may also be called intra-band MC positioning measurement.

In another example, the MC positioning measurement is performed by the UE on carriers belonging to different frequency bands (e.g., adjacent or overlapping bands). This may also be called inter-band MC positioning measurement.

In another example, the MC positioning measurement is performed by the UE on carriers which are adjacent (or contiguous) to each other in frequency domain. This may also be called an intra-band contiguous MC positioning measurement. The adjacent or contiguous carriers may or may not belong to the same band.

In another example, the MC positioning measurement is performed by the UE on carriers which are non-adjacent (or non-contiguous) to each other in frequency domain. This may also be called as intra-band non-contiguous MC positioning measurement. The non-adjacent or non-contiguous carriers may or may not belong to the same band.

### MC Positioning Capability Characteristics:

The MC positioning capability may be static (e.g., based on UE hardware and/or architecture capability) or change over time in semi-static or dynamic manner (e.g., based on change on resources, etc.). The MC positioning capability mechanism described hereinafter also provides solutions to the following UE limitations.

The UE may not have capability to simultaneously transmit UL data using carrier aggregation for communication purposes whilst also transmitting UL-SRS for positioning using carrier aggregation. This can be cumbersome in terms of maintaining synch with a number of carriers for simultaneous communication and positioning.

The UE may not have capability to simultaneously perform DL-PRS measurements using DL carrier aggregation for communication purpose whilst also performing wideband DL-PRS measurements for positioning using carrier aggregation.

The MC positioning capability may also be called a UE assistance information (UAI). For example, the MC positioning capability may further change over time based on one or more of the following factors or scenarios.

Based on available resources in UE. For example, based on current or expected resources (e.g., memory resources, processing resources/processing units, battery power, etc.) in the UE, the number of carriers on which the UE can perform the MC positioning measurement or certain type of MC positioning measurement may change.

Based on MC configuration used by the UE for communication. For example, based on current or expected MC configuration configured for performing the MC operation for communication, the number of carriers on which the UE can perform the MC positioning measurement or certain type of MC positioning measurement may change.

Therefore, the contents or any information or parameter about the UE's MC positioning capability transmitted by the UE to a network node may change over time.

In some embodiments, the MC positioning capability information comprises of one or more of the following parameters or set of information, which may also vary over time. The MC positioning capability information described below exemplifies the capability information 18 in FIG. 1.

In general, in some embodiments, the MC positioning capability indicates a multicarrier positioning configuration (MCPC) with which the UE can perform one or more positioning measurements. The MCPC may further depend on or associate with a type of positioning measurement and/or type of positioning method. The MCPC in some embodiments comprises of at least a number of carriers the UE can aggregate for performing positioning measurements. The number of carriers may further depend on the type of the MC positioning measurement performed on the carriers. For example, the UE may indicate that it can support up to N11 number of carriers for performing the positioning measurement, which is performed only on DL reference signals (e.g., PRS). Examples of such measurements are RSTD, PRS-RSRP, PRS-RSRPP, etc. In another example, the UE may indicate that it can support up to N12 number of carriers for performing the positioning measurement, which is performed on both DL reference signals (e.g., PRS) and UL reference signals (e.g., SRS). Examples of such measurements are UE Rx-Tx time difference, round trip time, etc. In one example, N11>N12, while in another example, N12>N11. In another example, the UE may indicate that it can support the same number of carriers for performing the positioning measurement regardless of whether it is performed on only DL RS or on both DL and UL reference signals.

The MC positioning capability may alternatively or additionally indicate the aggregated bandwidth or the range of the aggregated bandwidths over which the UE can perform the positioning measurement over a certain number of carriers. The aggregated bandwidth may also be called the positioning aggregated bandwidth, PRS aggregated bandwidth, SRS aggregated bandwidth, positioning aggregated BW class, etc. The aggregated bandwidth may be expressed in terms of unit of frequency e.g., in X11 MHz, X12 GHZ, etc. The aggregated bandwidth may also be expressed in terms of number of resource blocks (RBs), which further depends on the numerology (e.g., subcarrier spacing (SCS), cyclic prefix length, etc.) of the reference signals (e.g., PRS, SRS, etc.) used for performing the positioning measurement. The aggregated bandwidth may further depend on the type of the MC positioning measurement performed on the carriers. For example, the UE may indicate that it can support an aggregated bandwidth of up to N21 number of RBs (or X11 MHz) for performing the positioning measurement, which is performed only on DL reference signals (e.g., PRS). In another example, the UE may indicate that it can support up to N22 number of RBs (or X12 MHz) for performing the positioning measurement, which is performed on both DL reference signals (e.g., PRS) and UL reference signals (e.g., SRS). In one example, N21>N22, while in another example, N22>N21. In another example, the UE may indicate that it can support the same aggregated BW for performing the positioning measurement regardless of whether it is performed on only DL RS or on both DL and UL reference signals.

The MC positioning capability may alternatively or additionally indicate the bandwidth of each of the supported aggregated carriers over which the UE can perform the positioning measurement. The supported BW can be the same for all the carriers supported for MC positioning measurement. The supported BW can also be different for any two or more carriers supported for a MC positioning measurement. The bandwidth may also be called the positioning bandwidth, PRS bandwidth, SRS bandwidth, etc. The bandwidth may also be expressed in terms of unit of frequency and/or in terms of number of resource blocks (RBs), which further depends on the numerology of the reference signals used for performing the positioning measurement. The bandwidth may further depend on the type of the MC positioning measurement performed on the carriers. For example, the UE may indicate that it can support a bandwidth of up to N31 number of RBs (or X31 MHz) on each supported carrier for performing the positioning measurement, which is performed only on DL reference signals. In another example, the UE may indicate that it can support up to N32 number of RBs (or X32 MHz) on each supported carrier for performing the positioning measurement, which is performed on both DL and UL reference signals. In one example, N31>N32, while in another example, N32>N31. In another example, the UE may indicate that it can support BW on each carrier for performing the positioning measurement regardless of whether it is performed on only DL RS or on both DL and UL reference signals.

The MC positioning capability alternatively or additionally indicates the frequency relation (or relation in the frequency domain) between the carriers, which the UE can aggregate for performing positioning measurements. The frequency relation may further depend on the type of the positioning measurement, e.g., whether it is done on DL RS or on both DL RS and UL RS, etc. Examples of the frequency relation are whether aggregated carriers are in the same band or can be in different bands, whether aggregated carriers are adjacent or contiguous or can be non-adjacent or non-contiguous.

The MC positioning capability alternatively or additionally indicates the spatial relation between the carriers, which the UE can aggregate for performing positioning measurements. The spatial relation may further depend on the type of the positioning measurement, e.g., whether it is done on DL RS or on both DL RS and UL RS, etc. The spatial relation between carriers supported by the UE for performing MC positioning measurements may further depend on a frequency band or on a group of frequency bands supported by the UE.

The spatial relation between carriers supported by the UE for performing MC positioning measurements can be expressed in terms of one or more parameters or scenarios:

Type of deployment scenario. Examples of deployment scenario are whether the carriers are operated by the same network node or by the co-located network nodes (located at the same site or physical location), or are operated by different network nodes, which are not co-located at the same site or physical location. For example, the UE may indicate that it can perform a MC positioning measurement on carriers provided that the carriers are operated by the same network node or by the co-located network nodes. In another example, the UE may indicate that it can perform a MC positioning measurement on carriers regardless of whether the carriers are operated by the same network node or by the co-located network nodes.

Type of beam management. Beam management (BM) is a UE procedure for operating signals (e.g., beams in certain direction(s)) between the UE and the cells. The operating of signals comprises receiving signals from the cells and/or transmitting signals to the cells. Examples of BM are common beam management (CBM), independent beam management (IBM), etc. In one example, carriers for which the UE supports the CBM for operating signals can be used for performing the MC positioning measurement. In another example, carriers for which the UE supports the IBM for operating signals can be used for performing the MC positioning measurement. For signal reception based on CBM scheme, the UE can receive signals from the same receive (Rx) beam direction from all the cells involved in the CBM. For signal transmission based on CBM scheme, the UE can transmit signals in the same transmit (Tx) beam direction in all the cells involved in the CBM. The UE supporting CBM typically has one or a common receiver for receiving beams from, and/or a common transmitter for transmitting beams to, cells involved in CBM.

Maximum receive time difference (MRTD). For example, if the magnitude of the received timing difference of signals from any pair of cells at the UE are within a certain received time threshold (Hr), then those cells can be used by the UE for performing the MC positioning measurement; otherwise, they cannot be used by the UE for performing the MC positioning measurement. This condition may be applicable for positioning measurement performed on at least DL RS, e.g., on PRS. Examples of type of positioning measurements are RSTD, UE Rx-Tx time difference, PRS-RSRP, PRS-RSRPP, etc.

Maximum transmit time difference (MTTD). For example, if the magnitude of the difference between the transmit timings of signals from any pair of cells are within a certain threshold (Hc), then those cells can be used by the UE for performing the MC positioning measurement; otherwise, they cannot be used by the UE for performing the MC positioning measurement. This condition may be applicable for positioning measurement performed on at least UL RS e.g., on SRS. Examples of such measurements are UE Rx-Tx time difference, RTT, etc.

The MC positioning capability may alternatively or additionally indicate whether the UE can perform MC positioning measurement using measurement gaps and/or without measurement gaps. The UE may further indicate that it can support up to N31 number of aggregated carriers and/or up toa certain aggregated BW for performing the MC positioning measurement using measurement gaps. The UE may further indicate that it can support up to N32 number of aggregated carriers and/or up to a certain aggregated BW for performing the MC positioning measurement without measurement gaps. In another example, the UE may indicate that it can support the same number of aggregated carriers and/or same aggregated BW for performing the MC positioning measurement with or without measurement gaps.

The MC positioning capability may alternatively or additionally indicate whether the UE can perform a MC positioning measurement using measurement gaps while it also performs MC operation for communication during at least part of the positioning measurement period (e.g., over RSTD measurement period). In one example, the UE indicates that it cannot perform both the MC positioning measurement using measurement gaps and MC operation for communication during at least part of the positioning measurement period, e.g., if the UE does not support or currently lacks resources for both operations. In another example, the UE indicates that it can perform both the MC positioning measurement using measurement gaps and MC operation for communication during at least part of the positioning measurement period, e.g., if the UE supports it or currently sufficient resources for both operations. The UE may further indicate information about the supported MC configuration (e.g., number of carriers, maximum aggregated BW, etc.) for performing MC positioning measurement while it performs the MC operation for communication during at least part of the positioning measurement period.

For example, when a UE is configured with a MG (per-UE and per-FR), the UE is not required to conduct reception/transmission from/to NR serving cells when configured for MC (e.g., CA), but is expected to perform radio resource management (RRM) measurement(s) or PRS measurement(s), provided the UE is configured by LMF via LPP to and the signals used for random access procedure. In this scenario, the UE may report N_{CA,total} as its capability to perform a MC positioning measurement. During the measurement gap (MG), the UE is therefore expected to perform positioning measurements by aggregating PRS resources transmitted by the same TRP on multiple carriers/PFLs.

The MC positioning capability may alternatively or additionally indicate whether the UE can perform a MC positioning measurement without restricting or reducing its supported MC positioning configuration (MCPC) during data inactive time period (Toff). The UE may alternatively or additionally indicate whether the UE can perform a MC positioning measurement without restricting or reducing its supported MCPC during Toff depends on the length of Toff. Examples of MCPC are number of carriers and/or aggregated BW over which the UE can perform the MC positioning measurements. During Toff the UE is not expected to, or is not required to operate (e.g., receive and/or transmit) communication signals (e.g., does not operate DL and/or UL control channel such as PDCCH, PUCCH, DL and/or UL data channel such as PDSCH, PUSCH, etc.). On the other hand, during the data active time period (Ton) the UE is expected or required to operate DL and/or UL communication signals. Examples of Toff are a time period during which the serving cell (e.g., SCell, PSCell, etc.) is deactivated, a cell group (e.g., SCG) is deactivated, inactive time (e.g., OFF duration) of the DRX cycle, inactive time (e.g., OFF duration) of the extended DRX (eDRX) cycle, time period when DRX cycle is configured, time period when eDRX cycle is configured, etc. Examples of Ton are a time period during which the serving cell is activated, a cell group (e.g., SCG) is activated, active time (e.g., ON duration) of the DRX cycle, active time (e.g., ON duration, PTW, etc.) of the eDRX cycle, time period when DRX cycle is not configured, time period when eDRX cycle is not configured, etc. This is further described with examples below.

For example, the UE may indicate that it can perform a MC positioning measurement without restricting or reducing its supported MCPC during data Toff, but it can perform a MC positioning measurement during Ton using restricted or reduced MCPC. In another example, the UE may further indicate that the UE can perform a MC positioning measurement without restricting or reducing MCPC during Toff also while performing the MC operation for communication during at least part of the positioning measurement period (e.g., over RSTD measurement period). For example, assume that the UE is capable of performing a MC positioning measurement over a maximum of G11 number of carriers. During Toff, the UE can perform a MC positioning measurement over G11 number of carriers while also performing the MC operation for communication. However, during the Ton, the UE can perform a MC positioning measurement over G12 number of carriers; where G12<G11.

In another example, the UE may indicate that it can perform a MC positioning measurement without restricting or reducing its supported MCPC during data Toff provided that Toff is larger than a certain threshold (HT1) and/or Ton is below certain threshold (HT2); otherwise, it can perform a MC positioning measurement during Toff using a restricted or reduced MCPC. In another example, the UE may further indicate that the UE can perform a MC positioning measurement without restricting or reducing MCPC during Toff also while performing the MC operation for communication during at least part of the positioning measurement period (e.g., over RSTD measurement period) provided that Toff is larger than threshold (HT3) and/or Ton is below a certain threshold (HT4); otherwise, it can perform a MC positioning measurement during Toff using restricted or reduced MCPC. For example, during Toff, the UE can perform a MC positioning measurement over G11 number of carriers provided that Toff is larger than threshold (HT5) and/or Ton is smaller than another threshold (HT6). However, during the Ton or when Toff is less than or equal to HT5, the UE can perform a MC positioning measurement over G12 number of carriers; where G12<G11.

The MC positioning capability may alternatively or additionally indicate its supported MC positioning measurement configuration (MCPC), which depends on the RRC state of the UE. For example, the UE may indicate that it supports different MCPC when configured in low activity RRC state and when configured in high activity RRC state. The UE may indicate whether it supports the same or different MCPCs when configured in different types of low activity RRC state (e.g., RRC idle, RRC inactive state, etc.). For example, the UE may support MCPC1 and MCPC2 when configured in low activity RRC state and when configured in high activity RRC state, respectively; where MCPC1 and MCPC2 are different. In one example, MCPC1 comprises of fewer carriers and/or smaller aggregated BW, compared to those comprised in MCPC2. In another example, MCPC1 comprises of larger number of carriers and/or larger aggregated BW, compared to those comprised in MCPC2. The MCPC1 supported by the UE in low activity RRC state may further depend on the length of the configured DRX cycle and/or the length of the configured eDRX cycle. For example, the UE may support MCPC11 when DRX cycle is below a certain threshold (HD1) and/or when eDRX cycle is below a certain threshold (HD2); otherwise, the UE support MCPC12, where MCPC11 and MCPC12 are different. In one example, MCPC11 comprises of fewer carriers and/or smaller aggregated BW, compared to those comprised in MCPC12. In another example, MCPC11 comprises of larger number of carriers and/or larger aggregated BW, compared to those comprised in MCPC12.

The MC positioning capability may alternatively or additionally indicate the number (Ms) of samples required by the UE for performing the MC positioning measurement over the positioning measurement period. As an example, Ms may vary between 1 and 4. The parameter Ms is also called a number of PRS processing samples required for performing the positioning measurement. The parameter Ms may further depend on the MC positioning measurement configuration (MCPC) supported by the UE and/or the MCPC currently configured by the network node for the UE to perform the MC positioning measurement. For example, the UE indicates that it requires Ms1 number of samples for performing the MC positioning measurement using MCPC31 and requires Ms2 number of samples for performing the MC positioning measurement using MCPC32, where Ms1 and Ms2 are different, and MCPC31 and MCPC32 are different. In one example, Ms1<Ms2, provided that MCPC31 comprises of larger number of carriers and/or larger aggregated BW compared to those in MCPC32. In another example, Ms1>Ms2, provided that MCPC31 comprises of smaller number of carriers and/or smaller aggregated BW compared to those in MCPC32.

The MC positioning capability may alternatively or additionally indicate the length in time or time duration of a positioning measurement window (PMW) required by the UE for performing the MC positioning measurement. The parameter PMW is also called as PRS processing window (PPW) during which the UE performs the positioning measurement without measurement gaps. The parameter PMW may further depend on the MC positioning measurement configuration (MCPC) supported by the UE and/or the MCPC currently configured by the network node for the UE to perform the MC positioning measurement. For example, the UE indicates that it requires PMW of time duration of PWM1 for performing the MC positioning measurement using MCPC41 and requires PMW of time duration of PWM2 for performing the MC positioning measurement using MCPC42, where PMW1 and PMW2 are different, and MCPC41 and MCPC42 are different. In one example, PMW1<PMW2, provided that MCPC41 comprises of larger number of carriers and/or larger aggregated BW compared to those in MCPC42. In another example, PMW1>PMW2, provided that MCPC41 comprises of smaller number of carriers and/or smaller aggregated BW compared to those in MCPC42.

The MC positioning capability may alternatively or additionally indicate the number (Bs) of receive (Rx) beam sweeps required by the UE for performing the MC positioning measurement. As an example, Bs may vary between 1 and 8 or between 1 and 12 or between 1 and 18. The parameter Bs is also called as a Rx beam sweeping factor required for performing the positioning measurement. The parameter Bs may further depend on the MC positioning measurement configuration (MCPC) supported by the UE and/or the MCPC currently configured by the network node for the UE to perform the MC positioning measurement. For example, the UE indicates that it requires Bs1 number of Rx beam sweeps for performing the MC positioning measurement using MCPC51 and requires Bs2 number of samples for performing the MC positioning measurement using MCPC52, where Bs1 and Bs2 are different, and MCPC51 and MCPC52 are different. In one example, Bs1<Bs2, provided that MCPC51 comprises of larger number of carriers and/or larger aggregated BW compared to those in MCPC32. In another example, Bs1>Bs2, provided that MCPC51 comprises of smaller number of carriers and/or smaller aggregated BW compared to those in MCPC52.

The MC positioning capability may alternatively or additionally indicate (in the same MC positioning capability message or in a separate messages) information about the number of carriers and/or the aggregated BW the UE supports for MC operation for communication. The UE may further indicate (in the same MC positioning capability message or in a separate messages) information about the number of carriers and/or the aggregated BW the UE is currently using or is expected to use for MC operation for communication, e.g., over the next T11 time period. The UE may further indicate (in the same MC positioning capability message or in a separate messages) additional information about the carriers the UE is currently using or is expected to use for MC operation for communication, e.g., over the next T11 time period. Examples of the additional information are frequency channel number (e.g., ARFCN, NR-ARFCN, etc.) of the carriers in the DL and/or in the UL used for the communication, the frequency band(s) (e.g., band indicator or identifier(s)) of the carriers in the DL and/or in the UL used for the communication, type of MC operation (e.g., CA, DC, intra-band MC, inter-band MC, intra-band contiguous MC, intra-band non-contiguous MC, etc.). Another example of the additional information is an indication informing the network node (e.g., LMF, BS, etc.) whether or not the carriers and/or the aggregated BW configured for performing the MC positioning measurements are the same as the carriers and/or the aggregated BW configured for performing the MC operation for communication. In one example, the UE may indicate this information to the network node (e.g., location server) upon receiving assistance data requesting the UE to perform the MC positioning measurements on a certain number of carriers.

The UE may alternatively or additionally indicate information about the carriers and/or the aggregated BW the UE is configured (e.g., by location server) for performing the MC positioning measurements. The information about the carriers may comprise, for example, the number of carriers, carrier frequency of each carrier frequency, e.g., frequency channel number such as ARFCN, NR-ARFCN, an identifier of a MC configuration (e.g., pre-defined ID, etc.), etc. This information may be indicated to a network node (e.g., BS), which may use this information for performing one or more tasks, e.g., adapted MC operation for communication. For example, the BS may reconfigure the UE with the carriers for MC operation for communication that are also configured for MC positioning measurements. In another example, the BS may add, release, activate or deactivate one or more carriers the UE to perform the MC operation for communication.

The MC positioning capability may alternatively or additionally indicate the number of number of carriers the UE can aggregate and/or the aggregated BW for performing positioning measurements while the UE is also performing MC operation for communication signal (e.g., CA, DC, etc.). The number of carriers and/or the aggregated BW supported by the UE for performing positioning measurement may decrease with the increase in the number of carriers and/or the aggregated BW used by the UE for the MC operation for communication signals or vice versa. In one exemplary scenario, when the UE receives a request from the network node to report its MC positioning capability, the UE may already be involved in or configured with MC operation for communication. In this scenario, depending on the UE capability in terms of the total number of carriers it can combine for positioning measurements, the UE may bear a limitation on the number of carriers it may aggregate for communication and the number of carriers it may aggregate for positioning at a given instance. If, for example, N_{CA,total} denotes the UE capability in terms of the total number of carriers that it can combine to jointly process them, and the UE is already processing N_{CA,communication} number of serving carriers for communication then the UE may report (N_{CA,total}−N_{CA,communication}) as its MC positioning capability for performing positioning measurements to a network node (e.g., LMF, BS, etc.). The location server (e.g., LMF) upon receiving the UE capability on the number of carriers it is capable of combining for positioning measurements at a given instance, provides the relevant assistance data to the UE for bandwidth aggregation for positioning measurement provided that (N_{CA,total}−N_{CA,communication})>1.

The MC positioning capability may alternatively or additionally indicate when the UE is configured for MC operation for communication on a set of carriers (Sc), then whether the UE can perform a MC positioning measurement on Sc and/or on subset of Sc and/or on another set of carriers (Sp). The UE may alternatively or additionally indicate whether the carriers in Sc and/or the carriers in Sb should be in the same band or in a different band or whether they should be contiguous or can be non-contiguous in the frequency domain. For example, assume that the UE is configured to perform the MC operation for communication on L11 number of contiguous carriers (e.g., with CA) comprising of set Sc={F1, F2, F3 and F4} where L11=4. In one example, the UE capable of performing a MC positioning measurement on Sc or a subset of Sc, can indicate that it can perform the MC positioning measurement on any two or more of the carriers in set Sc. In another example, the UE capable of performing a MC positioning measurement on set Sp indicates that it can perform the MC positioning measurement on any two or more of carriers in set Sb. In another example, the UE capable of performing a MC positioning measurement on set Sp indicates that it can perform the MC positioning measurement on any two or more of carriers in set Sc or in Sb.

The MC positioning capability may alternatively or additionally indicate whether the MCPC supported by the UE is the same as the MC configuration for communication (MCCC) supported by the UE. The indication may be specific for each frequency band or for a group of frequency bands or for all frequency bands supported by the UE. If the UE indicates that it supports the same MCPC as for MCCC for a certain band or group of bands, then the UE may transmit information about the supported MCPC or MCCC to reduce signaling overheads. Otherwise, the UE transmits information about the supported MCPC and MCCC. In another example, if the UE indicates that the supported MCPC and MCCC are different for a certain band or group of bands then the UE may transmit information about the supported MCPC or MCCC, and about the aspects/parameters which are different between the supported MCPC and MCCC.

In any of the examples above, the UE may indicate one or more types of positioning measurements for which any one or more aspects of the MC positioning capability is applicable. For example, the UE may indicate whether it can perform only one type positioning measurement or a plurality of different types of positioning measurements on at least two aggregated carriers. Examples of types of positioning measurements are RSTD, UE Rx-Tx time difference, PRS-RSRP, PRS-RSRPP, etc.

In any of the examples above, the UE may alternatively or additionally indicate whether the MC positioning capability is applicable for certain frequency bands, for a group of frequency bands or for all the bands supported by the UE. The one or more aspects or characteristics of the MC positioning capability may be different for different supported frequency bands. For example, the UE may indicate that it can support up to L11 number of aggregated carriers on frequency band A and up to L12 number of aggregated carriers on frequency band B for performing MC positioning measurement.

Some of the above exemplary principles related to the adaptive MC capability are described below with examples:

### Examples Illustrating MC Positioning Capability

A general example in table 1 illustrates a relation between MCPC and MC configuration for communication (MCCC) supported by the UE. MCPC and MCCC can be expressed in terms of a number of carriers and/or aggregated BW and/or BW per carrier supported by the UE for MC positioning measurement and for MC operation for communication respectively. The relation may further depend on the frequency band or group of frequency bands, e.g., the relation between MCPC and MCCC is per frequency band or is band-specific.

Another general example in table 2 illustrates a relation between MCPC and MCCC expressed in terms of a maximum number of carriers supported by the UE for MC positioning measurement and for MC operation for communication, respectively.

A specific example in table 3 illustrates a relation between MCPC and MCCC expressed in terms of a maximum number of carriers supported by the UE for MC positioning measurement and for MC operation for communication, respectively. The example shows that to perform the MC positioning measurement over a larger number of carriers, the UE needs to reduce or lower the number of carriers for performing MC communication operation, or vice versa.

A general example in table 4 illustrates a relation between MCPC and MCCC expressed in terms of a maximum number of carriers and corresponding maximum aggregated BW supported by the UE for MC positioning measurement and for MC operation for communication, respectively.

A specific example in table 5 illustrates a relation between MCPC and MCCC expressed in terms of a maximum number of carriers and corresponding maximum aggregated BW supported by the UE for MC positioning measurement and for MC operation for communication, respectively. The example shows that to perform the MC positioning measurement over a larger number of carriers, the UE needs to reduce or lower the number of carriers and aggregated for performing MC communication operation, or vice versa.

In another specific example, depending on the band and the MC configuration for communication (MCCC) supported by UE, the serving cell provides the MC configuration to the UE for communication, e.g., configured with CA or DC. If the UE is configured to aggregate a maximum number of carriers it supports for communication, then the UE is not configured for bandwidth aggregation for positioning outside the measurement gap (MG). If the UE is configured for MC where the number of carriers is smaller than the supported MCCC, then the UE is configured to aggregate PRS resources for performing the MC positioning measurement. In the latter scenario, the UE is configured for bandwidth aggregation for positioning measurements if the number of spare CCs (not used for communication) that the UE can be configured is equal to or larger than a threshold, e.g., 2. When the UE is configured for bandwidth aggregation for positioning within MG, then the UE may be configured to aggregate PRS resources transmitted in all the supported CCs.

TABLE 1
A general example of mapping or relation between
MC positioning configuration (MCPC) and MC
communication configuration (MCCC)

| Configuration | MCPC supported for | MCCC supported for |
|---|---|---|
| ID | positioning measurements | communication |
| 1 | MCPC #1 (MCPC₁) | MCCC # 1 (MCC₁) |
| 2 | MCPC #2 (MCPC₂) | MCCC # 3 (MCCC₂) |
| 3 | MCPC #3 (MCPC₃) | MCCC # 3 (MCCC₃) |
| . . . | . . . | . . . |
| K | MCPC # K (MCPC_{K}) | MCCC # K (MCCC_{K}) |

TABLE 2
A general example of mapping or relation between
MCPC and MCCC in terms of number of carriers

| | Maximum number of aggregated | Maximum number of |
|---|---|---|
| Configuration | carriers supported for | CCs supported for |
| ID | positioning measurements | communication |
| 1 | P₁₁ | Q₁₁ |
| 2 | P₁₂ | Q₁₂ |
| 3 | P₁₃ | Q₁₃ |
| . . . | . . . | . . . |
| K | P_{1K} | Q_{1K} |

TABLE 3
A specific example of mapping or relation between
MCPC and MCCC in terms of number of carriers

| | Maximum number of aggregated | Maximum number of |
|---|---|---|
| Configuration | carriers supported for | CCs supported for |
| ID | positioning measurements | communication |
| 1 | 2 | 8 |
| 2 | 3 | 6 |
| 3 | 4 | 4 |
| 4 | 5 | 2 |
| 5 | 6 | 1 |

TABLE 4
A general example of mapping or relation between MCPC and MCCC
in terms of number of carriers and aggregated bandwidths

| | MCPC | | MCCC | |
|---|---|---|---|---|
| | Maximum number | Max aggregated | | Max |
| | of aggregated | BW supported | Maximum | aggregated BW |
| | carriers supported | for positioning | number of CCs | supported for |
| Configuration | for positioning | measurements | supported for | communication |
| ID | measurements | (BW_{P}) | communication | (BW_{C}) |
| 1 | P₁₁ | BW_{P} ≤ P₂₁ | Q₁₁ | Q₂₁ < BW_{C} ≤ Q₂₂ |
| 2 | P₁₂ | P₂₁ < BW_{P} ≤ P₂₂ | Q₁₂ | Q₂₂ < BW_{C} ≤ Q₂₃ |
| 3 | P₁₃ | P₂₂ < BW_{P} ≤ P₂₃ | Q₁₃ | Q₂₃ < BW_{C} ≤ Q₂₄ |
| . . . | . . . | . . . | . . . | . . . |
| K | P_{1K} | P_{2(K-1)} < BW_{P} ≤ P_{2K} | Q_{1K} | BW_{C} ≤ Q_{2K} |

TABLE 5
A specific example of mapping or relation between MCPC and MCCC
in terms of number of carriers and aggregated bandwidths

| | MCPC | | MCCC | |
|---|---|---|---|---|
| | Maximum number | Max aggregated | | Max |
| | of aggregated | BW supported | Maximum | aggregated BW |
| | carriers supported | for positioning | number of CCs | supported for |
| Configuration | for positioning | measurements | supported for | communication |
| ID | measurements | (BW_{P}) (MHz) | communication | (BW_{C}) (MHz) |
| 1 | 2 | BW_{P} ≤ 100 | 8 | 400 < BW_{C} ≤ 800 |
| 2 | 3 | 100 < BW_{P} ≤ 200 | 6 | 300 < BW_{C} ≤ 400 |
| 3 | 4 | 200 < BW_{P} ≤ 300 | 4 | 200 < BW_{C} ≤ 300 |
| 4 | 5 | 300 < BW_{P} ≤ 400 | 2 | 100 < BW_{C} ≤ 200 |
| 5 | 6 | 400 < BW_{P} ≤ 600 | 1 | BW_{C} ≤ 100 |

### UE Transmitting Adaptive MC Positioning Capability to a Network Node:

In one example, the UE may transmit the information related to MC positioning capability (described above) to a network node before the start of the positioning procedure, e.g., at the beginning of the positioning procedure. In another example, the UE may transmit the information related to MC positioning capability to a network node upon receiving a request from a network node. In another example, the UE may transmit the information related to MC positioning capability to a network node upon triggering one or more conditions or fulfillment of one or more criteria. Examples of such criteria are: (i) if any parameter (e.g., number of aggregated carriers, aggregated BWs, etc.) of the UE's MC positioning capability changes; (ii) if the availability of the resources in the UE changes, e.g., available memory is increased or decreased wrt reference value (e.g., current value); or (iii) if MC configuration for communication changes, etc. For example, with regard to (iii), if one or more carriers for MC communication operation are configured/added, deconfigured/release, activated or deactivated.

The UE may transmit the information related to one or more aspects of the MC positioning capability to one or plurality of network nodes, e.g., to a first network node (NW1, e.g., BS), to a second network node (NW2, e.g., location server such as LMF), etc. The UE may transmit the information to a network node via one or more messages using, e.g., RRC, LPP, etc. In one example the UE may transmit the information to a network node as part of capability information. In another example, the UE may transmit the information to a network node as part of assistance information, which may indicate the UE's preference or recommendation. Examples of assistance information messages are UE assistance information (UAI) sent by the UE to NW1 via RRC, Request Assistance Data message sent by the UE to NW2 via LPP, etc.

### UE Receiving Assistance Data and Performing MC Positioning Measurement:

The UE may receive assistance data from a network node (e.g., NW2) for performing the MC positioning measurement in response to the UE sending the MC positioning capability information to the network node. The UE may perform one or more MC positioning measurements based on or according to or by using the received assistance data. For example, the UE may perform bandwidth aggregation within MG or outside of MG. Depending on if the UE is performing bandwidth aggregation for positioning within MG or outside of MG, there can be a maximum number of carriers that the UE may be configured to aggregate for positioning measurement.

The UE may be indicated by the network node (e.g., NW2) not to perform the MC positioning measurement in response to the UE sending the MC positioning capability information to the network node.

The UE may be indicated by the network node (e.g., NW2) to perform the MC positioning measurement over a fewer number of carriers than the number of carriers previous configured for the MC positioning measurement in response to the UE sending the MC positioning capability information to the network node.

The UE may alternatively or additionally be configured to use the results of the MC positioning measurements for one or more operational tasks, e.g., (i) for transmitting the results of the MC positioning measurements to a network node, e.g., NW1, NW2, etc; (ii) for using the MC positioning measurements for determining the UE positioning; or (iii) for synchronization, for compensating the propagation delay between the UE and the base station, for transmitting the results of the timing measurements to the network node (e.g., location server, base station, etc.), etc.

### Embodiment 2: Method in a First Network Node of Receiving and Using UE Adaptive Capability to Aggregate Carriers for Positioning

According to one aspect of a second embodiment, a first network node (NW1) (e.g., a base station) serving the UE obtains information related to one or more parameters or aspects of the MC positioning capability of the UE and uses the obtained information for performing one or more operational tasks.

Examples of operational tasks are adapting the UE's MC configuration for MC operation for communication, rejecting or permitting the UE to perform the one or more MC positioning measurements, configuring the UE with a measurement gap pattern, deconfiguring the UE with the configured measurement gap pattern, etc. For example, NW1 based on the obtained information about the MC positioning capability may add, release, activate or deactivate one or more for carriers at the UE for performing MC operation for communication.

Examples of the parameters or aspects of the MC positioning capability of the UE are the same as described in the first embodiment (i.e., UE embodiment described herein).

NW1 may obtain the information related to one or more parameters or aspects of the MC positioning capability of the UE by one or more of the following mechanisms, e.g.: (i) by receiving the information from the UE, e.g., via RRC or MAC messages; (ii) by receiving the information from another network node, e.g., from a second network node (NW2) via NW1-NW2 signaling messages such as via NRPPa; or (iii) based on historical data or statistics related to the MC positioning capability of the UE.

According to another aspect of the second embodiment, NW1 serving the UE may inform NW2 information related to the MC configuration configured or expected to be configured at the UE for communication purpose, e.g., MCCC. NW1 may transmit this information to NW2 proactively or upon receiving request from NW2 or in response to the UE sending the MC positioning capability information to NW1.

According to another aspect of the second embodiment, another non-serving NW3 node, (e.g., a TRP), which is not serving the UE with communication services but is involved in positioning, may request and/or receive the UE MCCC capability and/or configuration from NW2 for the purpose of adapting its positioning signals to the UE capability. For example, having knowledge that positioning signals may be aggregated by the UE may cause the TRP to update/alter its PRS configuration in order to transmit its PRS over multiple carriers in the same symbol to be aggregated.

The MCCC may comprise information about the carriers for communication, which may further comprise for example, the number of carriers, carrier frequency of each carrier frequency, e.g., frequency channel number such as ARFCN, NR-ARFCN, etc.), an identifier of a MC configuration (e.g., pre-defined ID, etc.).

For example, based on the MC configuration for communication (MCCC), the UE may be configured to receive data in different CCs. Depending on which band(s) the CCs belong to, a UE may be configured for intra-band contiguous/non-contiguous MC or inter-band MC (e.g., CA). In one of the embodiments, it is claimed that the serving cell reports to the location server (e.g., LMF) the information about the number of CCs configured to the UE for communication. The location server (e.g., LMF) may use this information to configure the UE with the number of carriers the UE may aggregate for positioning measurements provided N_{CA,total}−N_{CA,communication}>1. Since CC configuration to the UE is dynamically done for communication, the serving cell is always aware of the UE capability in terms of the total number of carriers the UE can combine and the number of CCs the UE is configured for data reception via intra-band contiguous/non-contiguous or inter-band MC.

### Embodiment 3: Method in a Second Network Node of Receiving and Using UE Adaptive Capability to Aggregate Carriers for Positioning

According to a third embodiment, a second network node (NW2) (e.g., LMF) obtains information related to one or more parameters or aspects of the MC positioning capability of the UE and uses the obtained information for performing one or more operational tasks.

Examples of operational tasks are adapting the UE's MC configuration for positioning measurement, requesting NW1 to adapt or modify the UE's MC configuration for communication, receiving the MC positioning measurement results from the UE, using the received MC positioning measurement results for determining the UE location or position, etc. For example, NW2, based on the obtained information about the MC positioning capability, may add or release one or more for carriers at the UE for enabling the UE to perform the MC positioning measurement.

Examples of the parameters or aspects of the MC positioning capability of the UE are the same as described in the first embodiment (i.e., UE embodiment described herein).

NW2 may obtain the information related to one or more parameters or aspects of the MC positioning capability of the UE by one or more of the following mechanisms, e.g.: (i) by receiving the information from the UE, e.g., via LPP messages; (ii) by receiving the information from another network node, e.g., from a NW1 via NW1-NW2 signaling messages such as via NRPPa; or (iii) based on historical data or statistics related to the MC positioning capability of the UE.

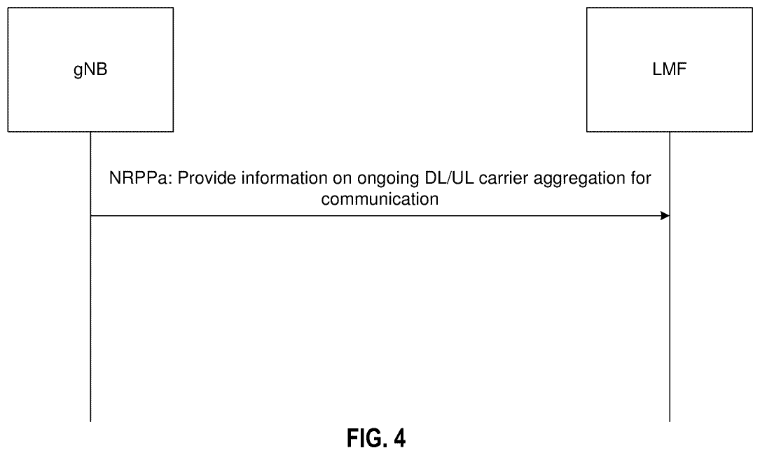

FIG. 4 shows one example of (ii), where NW2 in the form of LMF receives the information from a gNB via NRPPa, with the information being on ongoing DL/UL carrier aggregation for communication. gNB may provide information on any DL/UL component carriers used for carrier aggregation for data to LMF. gNB may recommend which D/UL carriers can be considered for DL-PRS/UL-SRS so that (i) the UE can perform the wide DL-PRS measurement along with maintaining (synchronizing) with the aggregated DL carriers (for enhanced throughput); and/or (ii) the UE can transmit wideband UL-SRS at the same time transmitting UL data using multicarrier.

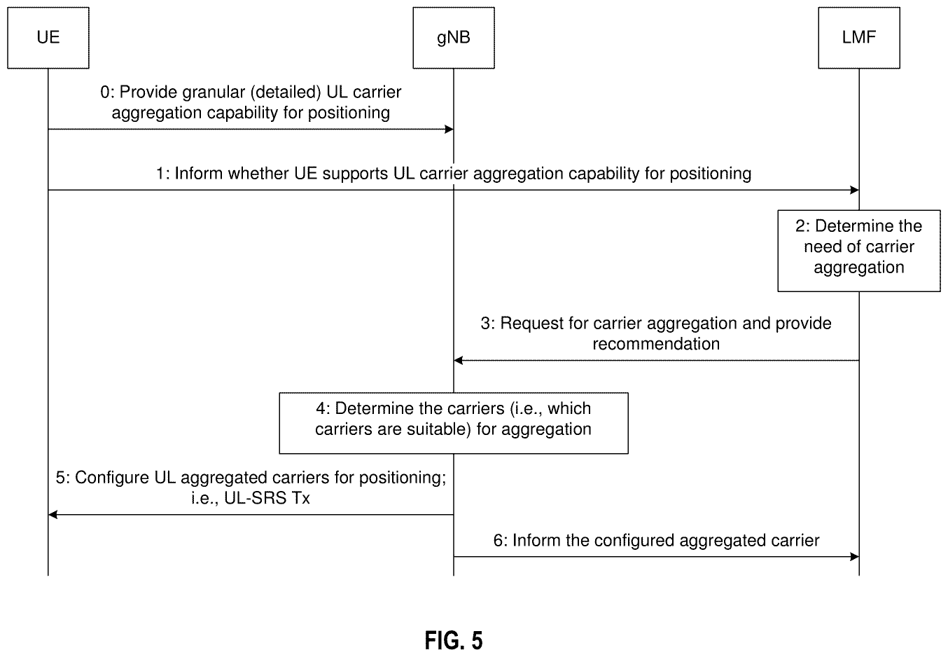

FIG. 5 shows an UL carrier aggregation signaling example according to some embodiments.

Step 0: UE provides detailed (e.g., per band) carrier aggregation capabilities for UL (in particular UL-SRS for positioning) to gNB base station, e.g., base station may fetch it from Access Mobility Function Node (AMF).

Step 1: UE provides on a high level whether it supports the carrier aggregation or not to LMF

Step 2: LMF determines if the gNBs (TRPs, RPs) need to perform positioning based upon wideband UL-SRS Tx

Step 3: LMF request the serving gNB and may also provide recommendation on component carriers. The request can be based upon, as an example, poor measurement results (Relative Time of Arrival; RTOA) based upon narrow bandwidth UL-SRS Tx. And, as examples, the recommendation can be based upon reciprocity (DL carrier aggregation of DL-PRS; how many carriers aggregate and what are the frequencies for carriers which are aggregated) and/or based upon UL-SRS Tx of other UEs.

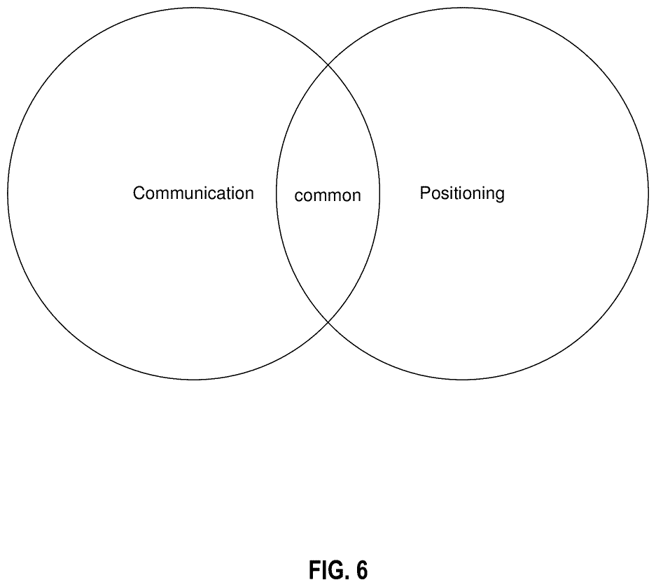

Step 4: gNB determines the component carrier for carrier aggregation. gNB may identify a set of common component carriers that could be used for both communication and positioning which may reduce UE complexity/effort; i.e., perform a union of component carriers for positioning and communication; and only selecting which are common. FIG. 6 shows for example a set of carriers commonly configured for communication and MC positioning.

Step 5: gNB configures the UL-SRS with component carriers (aggregated carrier).

Step 6: gNB provides the information to LMF

### Terminology

Some embodiments herein are described using a term node, which can be a network node or a user equipment (UE).

Examples of network nodes are NodeB, base station (BS), multi-standard radio (MSR) radio node such as MSR BS, eNodeB, gNodeB, Master eNB (MeNB), Secondary eNB (SeNB), location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, Centralized radio access network (C-RAN), access point (AP), transmission points, transmission nodes, transmission reception point (TRP), remote radio unit (RRU), remote radio head (RRH), nodes in distributed antenna system (DAS), core network node (e.g., mobile switching center (MSC), mobility management entity (MME), etc.), Operations and Maintenance (O&M), Operational Support System (OSS), Self-Organizing Network (SON), positioning node (e.g., Enhanced Serving Mobile Location Center (E-SMLC)), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE (MTC UE) or UE capable of machine to machine (M2M) communication, PDA, tablet, mobile terminals, smart phone, laptop embedded equipment (LEE), laptop mounted equipment (LME), USB dongles, etc.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal such as PSS, SSS, CSI-RS, Demodulation Reference Signal (DMRS), signals in SSB, Discovery Reference Signal (DRS), Cell Reference Signal (CRS), PRS, etc. Examples of UL physical signals are reference signal such as SRS, DMRS, etc. The term physical channel refers to any channel carrying higher layer information e.g., data, control, etc. Examples of physical channels are Physical Broadcast Channel (PBCH), Narrowband PBCH (NPBCH), PDCCH, PDSCH, short PUCCH (sPUCCH), short PDSCH (SPDSCH), Short PUCCH (sPUCCH), short PUSCH (sPUSCH), MTC PDCCH (MPDCCH), Narrowband PDCCH (NPDCCH), Narrowband PDSCH (NPDSCH), Enhanced PDCCH (E-PDCCH), PUSCH, PUCCH, Narrowband PUSCH (NPUSCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper SFN (H-SFN) cycle, etc.

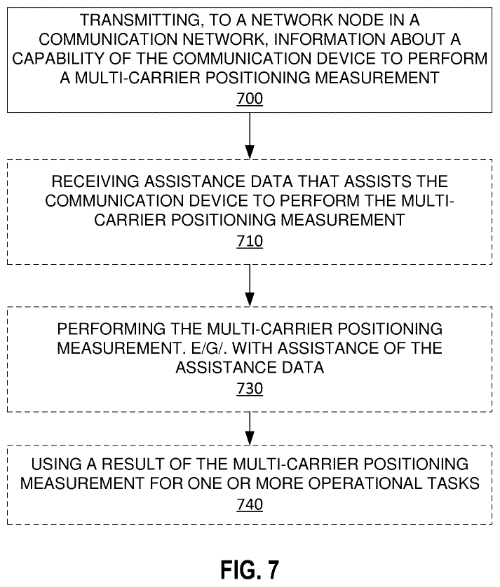

In view of the modifications and variations herein, FIG. 7 depicts a method performed by a communication device 12 in accordance with particular embodiments. The method includes transmitting, to a network node in a communication network 10, information 18 about a capability of the communication device 12 to perform a multi-carrier positioning measurement 14 (Block 700).

In some embodiments, the method further comprises receiving assistance data that assists the communication device 12 to perform the multi-carrier positioning measurement 14 (Block 710).

In some embodiments, the method further comprises performing the multi-carrier positioning measurement 14, e.g., with assistance of the assistance data (Block 730).

In some embodiments, the method further comprises using a result of the multi-carrier positioning measurement 14 for one or more operational tasks (Block 740).

In some embodiments, the multi-carrier positioning measurement 14 is a positioning measurement performed over aggregated carriers 16, carrier frequencies, positioning resources, or positioning frequency layers that are aggregated in a frequency domain.

In some embodiments, the multi-carrier positioning measurement 14 is a positioning measurement performed over two or more carriers 16 or carrier frequencies aggregated by the communication device 12 in multi-connectivity operation or carrier aggregation operation.

In some embodiments, the information 18 indicates a multi-carrier configuration 22 with which the communication device 12 is capable of performing the multi-carrier positioning measurement 14, In some embodiments, the multi-carrier configuration 22 is a configuration of at least a set of one or more carriers 16, carrier frequencies, positioning resources, or positioning frequency layers. In other embodiments, the multi-carrier configuration 22 is a configuration of at least a number of aggregated carriers 16, aggregated carrier frequencies, aggregated positioning resources, or aggregated positioning frequency layers. In yet other embodiments, the multi-carrier configuration 22 is a configuration of at least an aggregated frequency bandwidth. In still yet other embodiments, the multi-carrier configuration 22 is a configuration of at least a range of aggregated frequency bandwidths. In still yet other embodiments, the multi-carrier configuration 22 is a configuration of at least a bandwidth of aggregated reference signals or aggregated reference signal resources. In still yet other embodiments, the multi-carrier configuration 22 is a configuration of at least a range of bandwidth of aggregated reference signals or aggregated reference signal resources. In still yet other embodiments, the multi-carrier configuration 22 is a configuration of at least a bandwidth of reference signals or reference signal resources of each aggregated carrier, carrier frequency, positioning resource, or positioning frequency layer. In still yet other embodiments, the multi-carrier configuration 22 is a configuration of at least a bandwidth of each aggregated carrier, carrier frequency, positioning resource, or positioning frequency layer. In still yet other embodiments, the multi-carrier configuration 22 is a configuration of at least a frequency relation, and/or a spatial relation, between aggregated carriers 16, carrier frequencies, positioning resources, or positioning frequency layers. In some embodiments, the information 18 indicates whether the communication device 12 is capable of performing the multi-carrier positioning measurement 14 without restricting or reducing the multi-carrier configuration 22 during a data inactive time period.

In some embodiments, the information 18 indicates a set of one or more carriers 16, carrier frequencies, positioning resources, or positioning frequency layers, or a number of carriers 16, carrier frequencies, positioning resources, or positioning frequency layers, over which the communication device 12 is capable of performing the multi-carrier positioning measurement 14.

In some embodiments, the information 18 indicates an aggregated frequency bandwidth, or a range of aggregated frequency bandwidths, over which the communication device 12 is capable of performing the multi-carrier positioning measurement 14. In other embodiments, the information 18 alternatively or additionally indicates a bandwidth of each aggregated carrier, carrier frequency, positioning resource, or positioning frequency layer over which the communication device 12 is capable of performing the multi-carrier positioning measurement 14. In yet other embodiments, the information 18 alternatively or additionally indicates a frequency relation, and/or a spatial relation, between aggregated carriers 16, carrier frequencies, positioning resources, or positioning frequency layers over which the communication device 12 is capable of performing the multi-carrier positioning measurement 14.

In some embodiments, the information 18 indicates whether the communication device 12 is capable of performing the multi-carrier positioning measurement 14 with measurement gaps. In other embodiments, the information 18 alternatively or additionally indicates whether the communication device 12 is capable of performing the multi-carrier positioning measurement 14 without measurement gaps.

In some embodiments, the information 18 indicates one or more requirements that the communication device 12 requires for performing the multi-carrier positioning measurement 14 over a positioning measurement period. In some embodiments, the one or more requirements include at least a minimum number of samples required for performing the multi-carrier positioning measurement 14. In other embodiments, the one or more requirements include at least a minimum length or duration of the positioning measurement period required for performing the multi-carrier positioning measurement 14. In yet other embodiments, the one or more requirements include at least a minimum number of receive beam sweeps required for performing the multi-carrier positioning measurement 14.

In some embodiments, the one or more operational tasks include at least reporting the result of the multi-carrier positioning measurement 14. In some embodiments, the one or more operational tasks include at least determining a position of the communication device 12. In some embodiments, the one or more operational tasks include at least uplink timing synchronization. In some embodiments, the one or more operational tasks include at least synchronization with one or more cells. In some embodiments, the one or more operational tasks include at least propagation delay compensation.

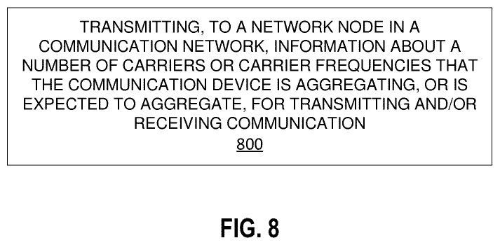

FIG. 8 depicts a method performed by a communication device 12 in accordance with other particular embodiments. The method includes transmitting, to a network node in a communication network 10, information about a number of carriers or carrier frequencies that the communication device 12 is aggregating, or is expected to aggregate, for transmitting and/or receiving communication (Block 800).

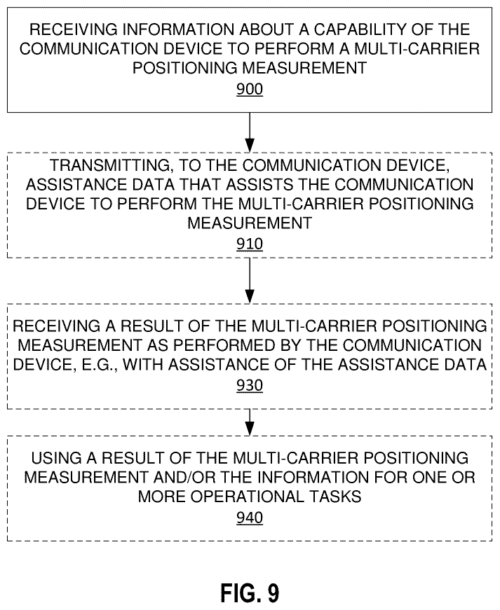

FIG. 9 depicts a method performed by a network node in a communication network 10 in accordance with particular embodiments. The method includes receiving information 18 about a capability of the communication device 12 to perform a multi-carrier positioning measurement 14 (Block 900).

In some embodiments, the method further comprises transmitting, to the communication device 12, assistance data that assists the communication device 12 to perform the multi-carrier positioning measurement 14 (Block 910).

In some embodiments, the method further comprises receiving a result of the multi-carrier positioning measurement 14 as performed by the communication device 12, e . . . g, with assistance of the assistance data (Block 930).

In some embodiments, the method further comprises using a result of the multi-carrier positioning measurement 14 and/or the received information 18 for one or more operational tasks (Block 940).

In some embodiments, the multi-carrier positioning measurement 14 is a positioning measurement performed over aggregated carriers 16, carrier frequencies, positioning resources, or positioning frequency layers that are aggregated in a frequency domain.

In some embodiments, the multi-carrier positioning measurement 14 is a positioning measurement performed over two or more carriers 16 or carrier frequencies aggregated by the communication device 12 in multi-connectivity operation or carrier aggregation operation.

In some embodiments, the information 18 indicates a multi-carrier configuration 22 with which the communication device 12 is capable of performing the multi-carrier positioning measurement 14. In some embodiments, the multi-carrier configuration 22 is a configuration of at least a set of one or more carriers 16, carrier frequencies, positioning resources, or positioning frequency layers. In other embodiments, the multi-carrier configuration 22 is a configuration of at least a number of aggregated carriers 16, aggregated carrier frequencies, aggregated positioning resources, or aggregated positioning frequency layers. In yet other embodiments, the multi-carrier configuration 22 is a configuration of at least an aggregated frequency bandwidth. In still yet other embodiments, the multi-carrier configuration 22 is a configuration of at least a range of aggregated frequency bandwidths. In still yet other embodiments, the multi-carrier configuration 22 is a configuration of at least a bandwidth of aggregated reference signals or aggregated reference signal resources. In still yet other embodiments, the multi-carrier configuration 22 is a configuration of at least a range of bandwidth of aggregated reference signals or aggregated reference signal resources. In still yet other embodiments, the multi-carrier configuration 22 is a configuration of at least a bandwidth of reference signals or reference signal resources of each aggregated carrier, carrier frequency, positioning resource, or positioning frequency layer. In still yet other embodiments, the multi-carrier configuration 22 is a configuration of at least a bandwidth of each aggregated carrier, carrier frequency, positioning resource, or positioning frequency layer. In still yet other embodiments, the multi-carrier configuration 22 is a configuration of at least a frequency relation, and/or a spatial relation, between aggregated carriers 16, carrier frequencies, positioning resources, or positioning frequency layers. In some embodiments, the information 18 indicates whether the communication device 12 is capable of performing the multi-carrier positioning measurement 14 without restricting or reducing the multi-carrier configuration 22 during a data inactive time period.

In some embodiments, the information 18 indicates a set of one or more carriers 16, carrier frequencies, positioning resources, or positioning frequency layers, or a number of carriers 16, carrier frequencies, positioning resources, or positioning frequency layers, over which the communication device 12 is capable of performing the multi-carrier positioning measurement 14.

In some embodiments, the information 18 indicates an aggregated frequency bandwidth, or a range of aggregated frequency bandwidths, over which the communication device 12 is capable of performing the multi-carrier positioning measurement 14. In other embodiments, the information 18 alternatively or additionally indicates a bandwidth of each aggregated carrier, carrier frequency, positioning resource, or positioning frequency layer over which the communication device 12 is capable of performing the multi-carrier positioning measurement 14. In yet other embodiments, the information 18 alternatively or additionally indicates a frequency relation, and/or a spatial relation, between aggregated carriers 16, carrier frequencies, positioning resources, or positioning frequency layers over which the communication device 12 is capable of performing the multi-carrier positioning measurement 14.

In some embodiments, the information 18 indicates whether the communication device 12 is capable of performing the multi-carrier positioning measurement 14 with measurement gaps. In other embodiments, the information 18 alternatively or additionally indicates whether the communication device 12 is capable of performing the multi-carrier positioning measurement 14 without measurement gaps.

In some embodiments, the information 18 indicates one or more requirements that the communication device 12 requires for performing the multi-carrier positioning measurement 14 over a positioning measurement period. In some embodiments, the one or more requirements include at least a minimum number of samples required for performing the multi-carrier positioning measurement 14. In other embodiments, the one or more requirements include at least a minimum length or duration of the positioning measurement period required for performing the multi-carrier positioning measurement 14. In yet other embodiments, the one or more requirements include at least a minimum number of receive beam sweeps required for performing the multi-carrier positioning measurement 14.

In some embodiments, the one or more operational tasks include at least determining a position of the communication device 12. In other embodiments, the one or more operational tasks include at least adapting a multi-carrier configuration 22 of the communication device 12 for multi-carrier communication. In yet other embodiments, the one or more operational tasks include at least prohibiting or allowing the communication device 12 to perform the multi-carrier positioning measurement 14. In still yet other embodiments, the one or more operational tasks include at least configuring, reconfiguring, or deconfiguring the communication device 12 with a measurement gap pattern.

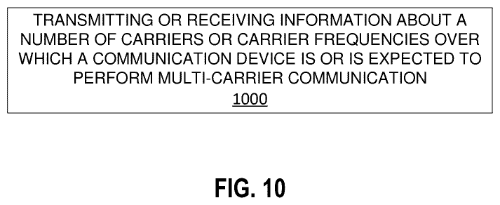

FIG. 10 depicts a method performed by a network node in a communication network 10 in accordance with other particular embodiments. The method includes transmitting or receiving information about a number of carriers or carrier frequencies over which a communication device 12 is or is expected to perform multi-carrier communication (Block 1000).

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node configured to perform any of the steps of any of the embodiments described above for the network node.

Embodiments also include a network node comprising processing circuitry and power supply circuitry. The processing circuitry is configured to perform any of the steps of any of the embodiments described above for the network node. The power supply circuitry is configured to supply power to the network node.

Embodiments further include a network node comprising processing circuitry. The processing circuitry is configured to perform any of the steps of any of the embodiments described above for the network node. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for the network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

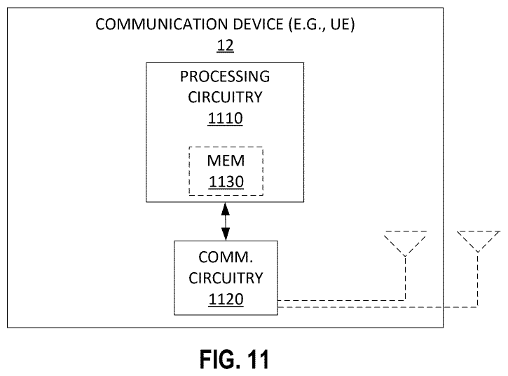

FIG. 11 for example illustrates a communication device 12 as implemented in accordance with one or more embodiments. As shown, the communication device 12includes processing circuitry 1110 and communication circuitry 1120. The communication circuitry 1120 (e.g., radio circuitry) is configured to transmit and/or receive information to and/or from one or more other nodes, e.g., via any communication technology. Such communication may occur via one or more antennas that are either internal or external to the communication device 12. The processing circuitry 1110 is configured to perform processing described above, e.g., in FIG. 7 and/or FIG. 8, such as by executing instructions stored in memory 1130. The processing circuitry 1110 in this regard may implement certain functional means, units, or modules.

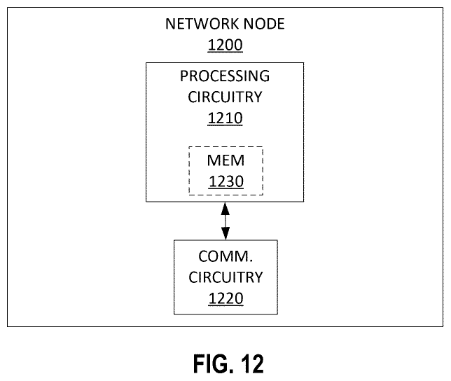

FIG. 12 illustrates a network node 1200 in a communication network 10 as implemented in accordance with one or more embodiments. The network node 1200 may for instance be a radio network node or a location server. As shown, the network node 1200 includes processing circuitry 1210 and communication circuitry 1220. The communication circuitry 1220 is configured to transmit and/or receive information to and/or from one or more other nodes, e.g., via any communication technology. The processing circuitry 1210 is configured to perform processing described above, e.g., in FIG. 9 and/or FIG. 10, such as by executing instructions stored in memory 1230. The processing circuitry 1210 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

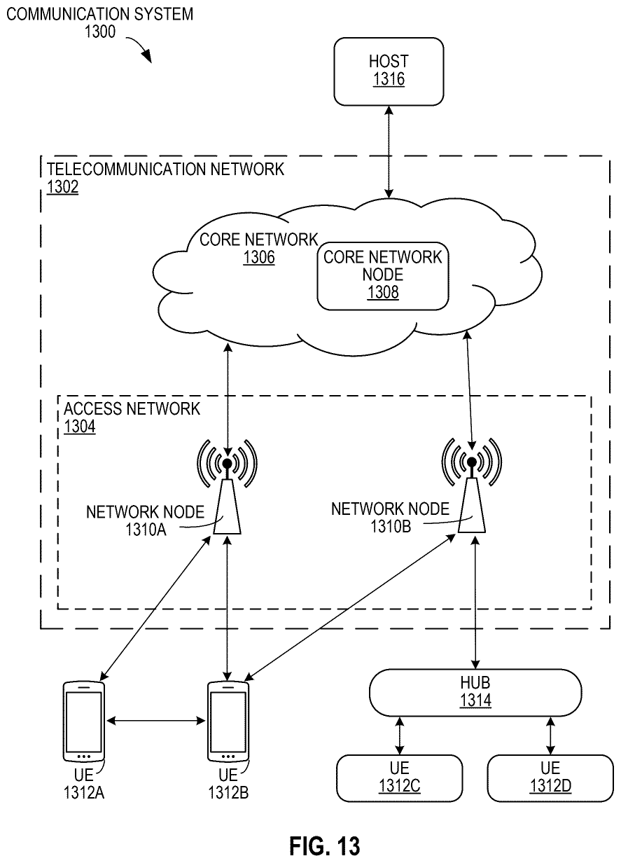

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, 47ncluding wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under t“e ow'ership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistenl or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

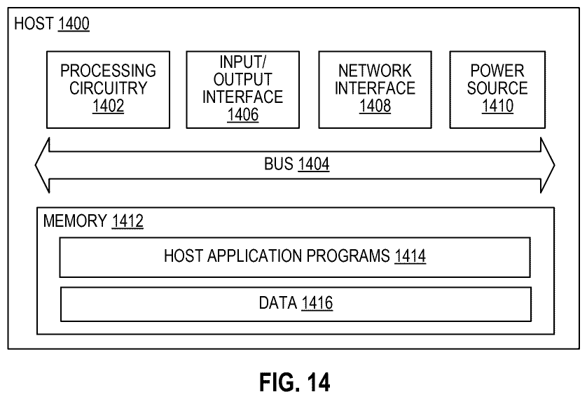

FIG. 14 is a block diagram of a host 1400, which may be an embodiment of the host 1316 of FIG. 13, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

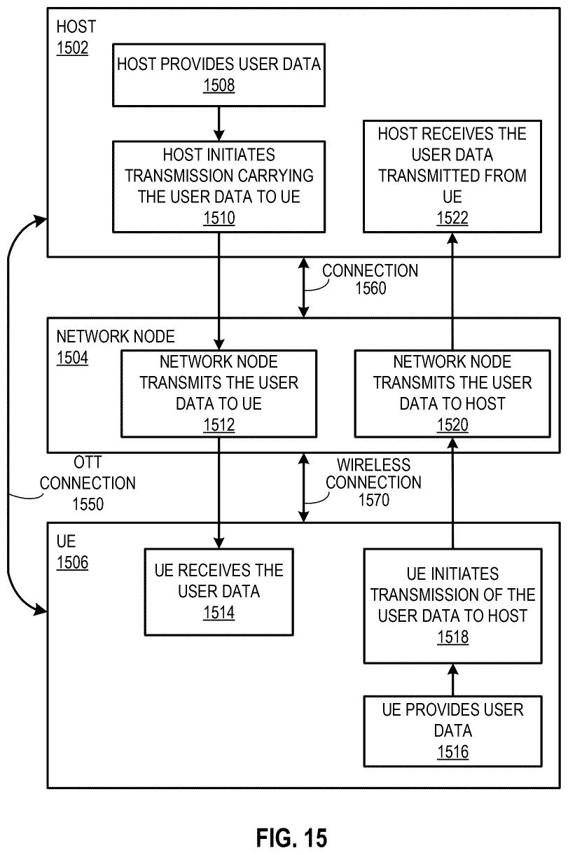

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 14 and 15, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1400 of FIG. 14) discussed in the preceding paragraphs will now be described with reference to FIG. 15.

Like host 1400, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1306 of FIG. 13) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, ‘he UE's client application may receive request data from th’ host's host application and provide user data in response to the request data. The OTT connection 1550 may transfer both the request data and the user data. ‘he UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams, etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing, etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally. Some embodiments herein are generally enumerated below as examples.

### Group A Embodiments

A1. A method performed by a communication device, the method comprising:
transmitting, to a network node in a communication network, information about a capability of the communication device to perform a multi-carrier positioning measurement.
   A2. The method of embodiment A1, wherein the multi-carrier positioning measurement is a positioning measurement performed over two or more aggregated carriers or carrier frequencies.
   A3. The method of any of embodiments A1-A2, wherein the multi-carrier positioning measurement is a positioning measurement performed over two or more carriers or carrier frequencies aggregated by the communication device in multi-connectivity operation or carrier aggregation operation.
   A4. The method of any of embodiments A1-A3, wherein the information indicates a multi-carrier configuration with which the communication device is capable of performing the multi-carrier positioning measurement.
   A5. The method of any of embodiments A1-A4, wherein the information indicates a multi-carrier configuration that the communication device supports for both performing the multi-carrier positioning measurement and transmitting and/or receiving communication during at least part of a positioning measurement period for performing the multi-carrier positioning measurement.
   A6. The method of any of embodiments A4-A5, wherein the multi-carrier configuration is a configuration of one or more of:
a set of one or more carriers or carrier frequencies;
a number of aggregated carriers or aggregated carrier frequencies;
an aggregated frequency bandwidth;
a range of aggregated frequency bandwidths;
a bandwidth of aggregated reference signals or aggregated reference signal resources;
a range of bandwidth of aggregated reference signals or aggregated reference signal resources;
a bandwidth of reference signals or reference signal resources of each aggregated carrier or carrier frequency;
a bandwidth of each aggregated carrier or carrier frequency; and/or
a frequency relation, and/or a spatial relation, between aggregated carriers or carrier frequencies.
   A7. The method of any of embodiments A4-A6, wherein the information indicates whether the communication device is capable of performing the multi-carrier positioning measurement without restricting or reducing the multi-carrier configuration during a data inactive time period.
   A8. The method of any of embodiments A4-A7, wherein the information indicates whether the multi-carrier configuration supported by the communication device for performing the multi-carrier positioning measurement is the same as a multi-carrier configuration supported by the communication device for transmitting and/or receiving communication.
   A9. The method of any of embodiments A1-A7, wherein the communication device is capable of and/or configured for multi-carrier communication on a set of multiple carriers, wherein the information indicates whether the communication device is capable of performing the multi-carrier positioning measurement on:
the same set of multiple carriers; and/or
a subset of the set of multiple carriers; and/or
a different set of multiple carriers.
   A10. The method of any of embodiments A1-A9, wherein the information indicates a set of one or more carriers or carrier frequencies, or a number of carriers or carrier frequencies, over which the communication device is capable of performing the multi-carrier positioning measurement.
   A11. The method of any of embodiments A1-A10, wherein the information indicates an aggregated frequency bandwidth, or a range of aggregated frequency bandwidths, over which the communication device is capable of performing the multi-carrier positioning measurement.
   A12. The method of any of embodiments A1-A11, wherein the information indicates a bandwidth of each aggregated carrier or carrier frequency over which the communication device is capable of performing the multi-carrier positioning measurement.
   A13. The method of any of embodiments A1-A12, wherein the information indicates a frequency relation, and/or a spatial relation, between aggregated carriers or carrier frequencies over which the communication device is capable of performing the multi-carrier positioning measurement.
   A14. The method of any of embodiments A1-A13, wherein the information indicates:
whether the communication device is capable of performing the multi-carrier positioning measurement with measurement gaps; and/or
whether the communication device is capable of performing the multi-carrier positioning measurement without measurement gaps.
   A15. The method of any of embodiments A1-A14, wherein the information indicates whether the communication device is capable of performing the multi-carrier positioning measurement with measurement gaps while also using multi-carrier operation to transmit and/or receive communication during at least part of a positioning measurement period for performing the
   A16. The method of any of embodiments A1-A15, wherein the information indicates one or more requirements that the communication device requires for performing the multi-carrier positioning measurement over a positioning measurement period, wherein the one or more requirements include one or more of:
a minimum number of samples required for performing the multi-carrier positioning measurement;
a minimum length or duration of the positioning measurement period required for performing the multi-carrier positioning measurement; and/or
a minimum number of receive beam sweeps required for performing the multi-carrier positioning measurement.
   A17. The method of any of embodiments A1-A16, further comprising receiving assistance data that assists the communication device to perform the multi-carrier positioning measurement.
   A18. The method of embodiment A17, wherein the assistance data is received responsive to, or after, transmitting the information.
   A19. The method of any of embodiments A17-A18, further comprising performing the multi-carrier positioning measurement with assistance of the assistance data.
   A20. The method of any of embodiments A1-A18, further comprising performing the multi-carrier positioning measurement.
   A21. The method of embodiment A20, further comprising using a result of the multi-carrier positioning measurement for one or more operational tasks.
   A22. The method of embodiment A21, wherein the one or more operational tasks include one or more of:
reporting the result of the multi-carrier positioning measurement;
determining a position of the communication device;
uplink timing synchronization;
synchronization with one or more cells; and
propagation delay compensation.
   A23. The method of any of embodiments A1-A22, wherein the network node is a radio network node.
   A24. The method of any of embodiments A1-A23, wherein the information is transmitting via radio resource control, RRC, signaling.
   A25. The method of any of embodiments A1-A22, wherein the network node is a location server.
   A26. The method of any of embodiments A1-A22 and A25, wherein the information is transmitted via a Long Term Evolution, LTE, positioning protocol or a New Radio, NR, positioning protocol.
   AA1. A method performed by a communication device, the method comprising:
transmitting, to a network node in a communication network, information about a number of carriers or carrier frequencies that the communication device is aggregating, or is expected to aggregate, for transmitting and/or receiving communication.
   AA2. The method of embodiment AA1, wherein the network node is a location server.
   AA3. The method of any of embodiments AA1-AA2, wherein the information is transmitted via a positioning protocol.
   AA. The method of any of the previous embodiments, further comprising:
providing user data; and
forwarding the user data to a host computer via the transmission to a base station.

### Group B Embodiments

B1. A method performed by a network node in a communication network, the method comprising:
receiving information about a capability of a communication device to perform a multi-carrier positioning measurement.
   B2. The method of embodiment B1, wherein the multi-carrier positioning measurement is a positioning measurement performed over two or more aggregated carriers or carrier frequencies.
   B3. The method of any of embodiments B1-B2, wherein the multi-carrier positioning measurement is a positioning measurement performed over two or more carriers or carrier frequencies aggregated by the communication device in multi-connectivity operation or carrier aggregation operation.
   B4. The method of any of embodiments B1-B3, wherein the information indicates a multi-carrier configuration with which the communication device is capable of performing the multi-carrier positioning measurement.
   B5. The method of any of embodiments B1-B4, wherein the information indicates a multi-carrier configuration that the communication device supports for both performing the multi-carrier positioning measurement and transmitting and/or receiving communication during at least part of a positioning measurement period for performing the multi-carrier positioning measurement.
   B6. The method of any of embodiments B4-B5, wherein the multi-carrier configuration is a configuration of one or more of:
a set of one or more carriers or carrier frequencies;
a number of aggregated carriers or aggregated carrier frequencies;
an aggregated frequency bandwidth;
a range of aggregated frequency bandwidths;
a bandwidth of aggregated reference signals or aggregated reference signal resources;
a range of bandwidth of aggregated reference signals or aggregated reference signal resources;
a bandwidth of reference signals or reference signal resources of each aggregated carrier or carrier frequency;
a bandwidth of each aggregated carrier or carrier frequency; and/or
a frequency relation, and/or a spatial relation, between aggregated carriers or carrier frequencies.
   B7. The method of any of embodiments B4-B6, wherein the information indicates whether the communication device is capable of performing the multi-carrier positioning measurement without restricting or reducing the multi-carrier configuration during a data inactive time period.
   B8. The method of any of embodiments B4-B7, wherein the information indicates whether the multi-carrier configuration supported by the communication device for performing the multi-carrier positioning measurement is the same as a multi-carrier configuration supported by the communication device for transmitting and/or receiving communication.
   B9. The method of any of embodiments B1-B7, wherein the communication device is capable of and/or configured for multi-carrier communication on a set of multiple carriers, wherein the information indicates whether the communication device is capable of performing the multi-carrier positioning measurement on:
the same set of multiple carriers; and/or
a subset of the set of multiple carriers; and/or
a different set of multiple carriers.
   B10. The method of any of embodiments B1-BA9, wherein the information indicates a set of one or more carriers or carrier frequencies, or a number of carriers or carrier frequencies, over which the communication device is capable of performing the multi-carrier positioning measurement.
   B11. The method of any of embodiments B1-B10, wherein the information indicates an aggregated frequency bandwidth, or a range of aggregated frequency bandwidths, over which the communication device is capable of performing the multi-carrier positioning measurement.
   B12. The method of any of embodiments B1-B11, wherein the information indicates a bandwidth of each aggregated carrier or carrier frequency over which the communication device is capable of performing the multi-carrier positioning measurement.
   B13. The method of any of embodiments B1-B12, wherein the information indicates a frequency relation, and/or a spatial relation, between aggregated carriers or carrier frequencies over which the communication device is capable of performing the multi-carrier positioning measurement.
   B14. The method of any of embodiments B1-B13, wherein the information indicates:
whether the communication device is capable of performing the multi-carrier positioning measurement with measurement gaps; and/or
whether the communication device is capable of performing the multi-carrier positioning measurement without measurement gaps.
   B15. The method of any of embodiments B1-B14, wherein the information indicates whether the communication device is capable of performing the multi-carrier positioning measurement with measurement gaps while also using multi-carrier operation to transmit and/or receive communication during at least part of a positioning measurement period for performing the multi-carrier positioning measurement.
   B16. The method of any of embodiments B1-B15, wherein the information indicates one or more requirements that the communication device requires for performing the multi-carrier positioning measurement over a positioning measurement period, wherein the one or more requirements include one or more of:
a minimum number of samples required for performing the multi-carrier positioning measurement;
a minimum length or duration of the positioning measurement period required for performing the multi-carrier positioning measurement; and/or
a minimum number of receive beam sweeps required for performing the multi-carrier positioning measurement.
   B17. The method of any of embodiments B1-B16, further comprising transmitting, to the communication device, assistance data that assists the communication device to perform the multi-carrier positioning measurement.
   B18. The method of embodiment B17, wherein the assistance data is transmitted responsive to, or after, receiving the information.
   B19. The method of any of embodiments B17-B18, further comprising receiving a result of the multi-carrier positioning measurement performed with assistance of the assistance data.
   B20. The method of any of embodiments B1-B18, further comprising receiving a result of the multi-carrier positioning measurement as performed by the communication device.
   B21. The method of any of embodiments B1-B20, further comprising using information to perform one or more operational tasks.
   B22. The method of embodiment B21, wherein the one or more operational tasks include one or more of:
determining a position of the communication device;
adapting a multi-carrier configuration of the communication device for multi-carrier communication;
prohibiting or allowing the communication device to perform the multi-carrier positioning measurement; and/or
configuring or deconfiguring the communication device with a measurement gap pattern.
   B23. The method of any of embodiments B1-B22, wherein the network node is a radio network node.
   B24. The method of any of embodiments B1-B23, wherein the information is received from the communication device and/or is received via radio resource control, RRC, signaling.
   B25. The method of any of embodiments B1-B22, wherein the network node is a location server.
   B26. The method of any of embodiments B1-B22 and B25, wherein the information is received from a radio network node and/or is received via a Long Term Evolution, LTE, positioning protocol or a New Radio, NR, positioning protocol.
   BB1. A method performed by a network node in a communication network, the method comprising:
transmitting or receiving information about a number of carriers or carrier frequencies over which a communication device is or is expected to perform multi-carrier communication.
   BB2. The method of embodiment BB1, wherein said multi-carrier communication comprises the communication device aggregating carriers or carrier frequencies for transmitting and/or receiving communication.
   BB3. The method of any of embodiments BB1-BB2, wherein said transmitting or receiving comprises transmitting the information to another network node.
   BB4. The method of embodiment BB1, wherein the network node is a radio network node and wherein the another network node is a location server.
   BB. The method of any of the previous embodiments, further comprising:
obtaining user data; and
forwarding the user data to a host computer or a communication device.

### Group C Embodiments

C1. A communication device configured to perform the method of any of the Group A embodiments.
C2. A communication device comprising processing circuitry configured to perform the method of any of the Group A embodiments.
C3. A communication device comprising:
communication circuitry; and
processing circuitry configured to perform the method of any of the Group A embodiments.
   C4. A communication device comprising:
processing circuitry configured to perform the method of any of the Group A embodiments; and
power supply circuitry configured to supply power to the communication device.
   C5. A communication device comprising:
processing circuitry and memory, the memory containing instructions executable by the processing circuitry whereby the communication device is configured to perform the method of any of the Group A embodiments.
   C6. The communication device of any of embodiments C1-C5, wherein the communication device is a wireless communication device.
   C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C8. A computer program comprising instructions which, when executed by at least one processor of a communication device, causes the communication device to perform the method of any of the Group A embodiments.
   C9. A carrier containing the computer program of embodiment C7, wherein the carrier is one of an electronic signal, optical signal, radio signal, or computer readable storage medium.
   C10. A network node configured to perform the method of any of the Group B embodiments.
   C11. A network node comprising processing circuitry configured to perform the method of any of the Group B embodiments.
   C12. A network node comprising:
communication circuitry; and
processing circuitry configured to perform the method of any of the Group B embodiments.
   C13. A network node comprising:
processing circuitry configured to perform the method of any of the Group B embodiments;
power supply circuitry configured to supply power to the network node.
   C14. A network node comprising:
processing circuitry and memory, the memory containing instructions executable by the processing circuitry whereby the network node is configured to perform the method of any of the Group B embodiments.
   C15. The network node of any of embodiments C10-C14, wherein the network node is a base station.
   C16. A computer program comprising instructions which, when executed by at least one processor of a network node, causes the network node to perform the method of any of the Group B embodiments.
   C17. The computer program of embodiment C16, wherein the network node is a base station.
   C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the method of any of the Group B embodiments to transmit the user data from the host to the UE.
   D2. The host of the previous embodiment, wherein:
the processing circuitry of the host is configured to execute a host application that provides the user data; and
the UE comprises processing circuitry configured to execute a client application associated with the host application to receive the transmission of user data from the host.
   D3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the method of any of the Group B embodiments to transmit the user data from the host to the UE.
   D4. The method of the previous embodiment, further comprising, at the network node, transmitting the user data provided by the host for the UE.
   D5. The method of any of the previous 2 embodiments, wherein the user data is provided at the host by executing a host application that interacts with a client application executing on the UE, the client application being associated with the host application.
   D6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the method of any of the Group B embodiments to transmit the user data from the host to the UE.
   D7. The communication system of the previous embodiment, further comprising:
the network node; and/or
the user equipment.
   D8. The communication system of the previous 2 embodiments, wherein:
the processing circuitry of the host is configured to execute a host application, thereby providing the user data; and
the host application is configured to interact with a client application executing on the UE, the client application being associated with the host application.
   D9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform method of any of the Group B embodiments to receive the user data from the UE for the host.
   D10. The host of the previous 2 embodiments, wherein:
the processing circuitry of the host is configured to execute a host application, thereby providing the user data; and
the host application is configured to interact with a client application executing on the UE, the client application being associated with the host application.
   D11. The host of the any of the previous 2 embodiments, wherein the initiating receipt of the user data comprises requesting the user data.
   D12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the method of any of the Group B embodiments to receive the user data from the UE for the host.
   D13. The method of the previous embodiment, further comprising at the network node, transmitting the received user data to the host.
   D14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the method of any of the Group A embodiments to receive the user data from the host.
   D15. The host of the previous embodiment, wherein the cellular network further includes a network node configured to communicate with the UE to transmit the user data to the UE from the host.
   D16. The host of the previous 2 embodiments, wherein:
the processing circuitry of the host is configured to execute a host application, thereby providing the user data; and
the host application is configured to interact with a client application executing on the UE, the client application being associated with the host application.
   D17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the method of any of the Group A embodiments to receive the user data from the host.
   D18. The method of the previous embodiment, further comprising:
at the host, executing a host application associated with a client application executing on the UE to receive the user data from the UE.
   D19. The method of the previous embodiment, further comprising:
at the host, transmitting input data to the client application executing on the UE, the input data being provided by executing the host application,
wherein the user data is provided by the client application in response to the input data from the host application.
   D20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the method of any of the Group A embodiments to transmit the user data to the host.
   D21. The host of the previous embodiment, wherein the cellular network further includes a network node configured to communicate with the UE to transmit the user data from the UE to the host.
   D22. The host of the previous 2 embodiments, wherein:
the processing circuitry of the host is configured to execute a host application, thereby providing the user data; and
the host application is configured to interact with a client application executing on the UE, the client application being associated with the host application.
   D23. A method implemented by a host configured to operate in a communication system that further includes a network node and a user equipment (UE), the method comprising:
at the host, receiving user data transmitted to the host via the network node by the UE, wherein the UE performs the method of any of the Group A embodiments to transmit the user data to the host.
   D24. The method of the previous embodiment, further comprising:
at the host, executing a host application associated with a client application executing on the UE to receive the user data from the UE.
   D25. The method of the previous embodiments, further comprising:
at the host, transmitting input data to the client application executing on the UE, the input data being provided by executing the host application,
wherein the user data is provided by the client application in response to the input data from the host application.

1.-32. (canceled)

33. A method performed by a communication device, the method comprising:
transmitting, to a network node in a communication network, information about a capability of the communication device to perform a multi-carrier positioning measurement; and
performing the multi-carrier positioning measurement.

34. The method of claim 33, wherein the multi-carrier positioning measurement is a positioning measurement performed over aggregated carriers, carrier frequencies, positioning resources, or positioning frequency layers that are aggregated in a frequency domain.

35. The method of claim 33, wherein the multi-carrier positioning measurement is a positioning measurement performed over two or more carriers or carrier frequencies aggregated by the communication device in multi-connectivity operation or carrier aggregation operation.

36. The method of claim 33, wherein the information indicates a multi-carrier configuration with which the communication device is capable of performing the multi-carrier positioning measurement, wherein the multi-carrier configuration is a configuration of one or more of:
a set of one or more carriers, carrier frequencies, positioning resources, or positioning frequency layers;
a number of aggregated carriers, aggregated carrier frequencies, aggregated positioning resources, or aggregated positioning frequency layers;
an aggregated frequency bandwidth;
a range of aggregated frequency bandwidths;
a bandwidth of aggregated reference signals or aggregated reference signal resources;
a range of bandwidth of aggregated reference signals or aggregated reference signal resources;
a bandwidth of reference signals or reference signal resources of each aggregated carrier, carrier frequency, positioning resource, or positioning frequency layer;
a bandwidth of each aggregated carrier, carrier frequency, positioning resource, or positioning frequency layer; and/or
a frequency relation, and/or a spatial relation, between aggregated carriers, carrier frequencies, positioning resources, or positioning frequency layers.

37. The method of claim 36, wherein the information indicates whether the communication device is capable of performing the multi-carrier positioning measurement without restricting or reducing the multi-carrier configuration during a data inactive time period.

38. The method of claim 33, wherein the information indicates a set of one or more carriers, carrier frequencies, positioning resources, or positioning frequency layers, or a number of carriers, carrier frequencies, positioning resources, or positioning frequency layers, over which the communication device is capable of performing the multi-carrier positioning measurement.

39. The method of claim 33, wherein the information indicates:
an aggregated frequency bandwidth, or a range of aggregated frequency bandwidths, over which the communication device is capable of performing the multi-carrier positioning measurement;
a bandwidth of each aggregated carrier, carrier frequency, positioning resource, or positioning frequency layer over which the communication device is capable of performing the multi-carrier positioning measurement; and/or
a frequency relation, and/or a spatial relation, between aggregated carriers, carrier frequencies, positioning resources, or positioning frequency layers over which the communication device is capable of performing the multi-carrier positioning measurement.

40. The method of claim 33, wherein the information indicates:
whether the communication device is capable of performing the multi-carrier positioning measurement with measurement gaps; and/or
whether the communication device is capable of performing the multi-carrier positioning measurement without measurement gaps.

41. The method of claim 33, wherein the information indicates one or more requirements that the communication device requires for performing the multi-carrier positioning measurement over a positioning measurement period, wherein the one or more requirements include one or more of:
a minimum number of samples required for performing the multi-carrier positioning measurement;
a minimum length or duration of the positioning measurement period required for performing the multi-carrier positioning measurement; and/or
a minimum number of receive beam sweeps required for performing the multi-carrier positioning measurement.

42. The method of claim 33, further comprising:
performing the multi-carrier positioning measurement; and
using a result of the multi-carrier positioning measurement for one or more operational tasks.

43. The method of claim 42, wherein the one or more operational tasks include one or more of:
reporting the result of the multi-carrier positioning measurement;
determining a position of the communication device;
uplink timing synchronization;
synchronization with one or more cells; and
propagation delay compensation.

44. A method performed by a network node in a communication network, the method comprising:
receiving information about a capability of a communication device to perform a multi-carrier positioning measurement; and
using the information to perform one or more operational tasks.

45. The method of claim 44, wherein the multi-carrier positioning measurement is a positioning measurement performed over aggregated carriers, carrier frequencies, positioning resources, or positioning frequency layers that are aggregated in a frequency domain.

46. The method of claim 44, wherein the multi-carrier positioning measurement is a positioning measurement performed over two or more carriers or carrier frequencies aggregated by the communication device in multi-connectivity operation or carrier aggregation operation.

47. The method of claim 44, wherein the information indicates a multi-carrier configuration with which the communication device is capable of performing the multi-carrier positioning measurement, wherein the multi-carrier configuration is a configuration of one or more of:
a set of one or more carriers, carrier frequencies, positioning resources, or positioning frequency layers;
a number of aggregated carriers, aggregated carrier frequencies, aggregated positioning resources, or aggregated positioning frequency layers;
an aggregated frequency bandwidth;
a range of aggregated frequency bandwidths;
a bandwidth of aggregated reference signals or aggregated reference signal resources;
a range of bandwidth of aggregated reference signals or aggregated reference signal resources;
a bandwidth of reference signals or reference signal resources of each aggregated carrier, carrier frequency, positioning resource, or positioning frequency layer;
a bandwidth of each aggregated carrier, carrier frequency, positioning resource, or positioning frequency layer; and/or
a frequency relation, and/or a spatial relation, between aggregated carriers, carrier frequencies, positioning resources, or positioning frequency layers.

48. The method of claim 47, wherein the information indicates whether the communication device is capable of performing the multi-carrier positioning measurement without restricting or reducing the multi-carrier configuration during a data inactive time period.

49. The method of claim 44, wherein the information indicates a set of one or more carriers, carrier frequencies, positioning resources, or positioning frequency layers, or a number of carriers, carrier frequencies, positioning resources, or positioning frequency layers, over which the communication device is capable of performing the multi-carrier positioning measurement.

50. The method of claim 44, wherein the information indicates:
an aggregated frequency bandwidth, or a range of aggregated frequency bandwidths, over which the communication device is capable of performing the multi-carrier positioning measurement;
a bandwidth of each aggregated carrier, carrier frequency, positioning resource, or positioning frequency layer over which the communication device is capable of performing the multi-carrier positioning measurement; and/or
a frequency relation, and/or a spatial relation, between aggregated carriers, carrier frequencies, positioning resources, or positioning frequency layers over which the communication device is capable of performing the multi-carrier positioning measurement.

51. The method of claim 44, wherein the information indicates:
whether the communication device is capable of performing the multi-carrier positioning measurement with measurement gaps; and/or
whether the communication device is capable of performing the multi-carrier positioning measurement without measurement gaps.

52. The method of claim 44, wherein the information indicates one or more requirements that the communication device requires for performing the multi-carrier positioning measurement over a positioning measurement period, wherein the one or more requirements include one or more of:
a minimum number of samples required for performing the multi-carrier positioning measurement;
a minimum length or duration of the positioning measurement period required for performing the multi-carrier positioning measurement; and/or
a minimum number of receive beam sweeps required for performing the multi-carrier positioning measurement.

53. The method of claim 44, wherein the one or more operational tasks include one or more of:
determining a position of the communication device;
adapting a multi-carrier configuration of the communication device for multi-carrier communication;
prohibiting or allowing the communication device to perform the multi-carrier positioning measurement; and/or
configuring, reconfiguring, or deconfiguring the communication device with a measurement gap pattern.

54. A communication device comprising:
communication circuitry; and
processing circuitry configured to:
transmit, to a network node in a communication network, information about a capability of the communication device to perform a multi-carrier positioning measurement; and
perform the multi-carrier positioning measurement.

55. A network node of a communication network, the network node comprising:
communication circuitry; and
processing circuitry configured to:
receive information about a capability of a communication device to perform a multi-carrier positioning measurement; and
use the information to perform one or more operational tasks.
